(19) United States
(12) Patent Application Publication
(10) Pub. No.: US 2019/0362292 A1
(43) Pub. Date: Nov. 28, 2019

(54) SYSTEM AND METHOD FOR ORDER VERIFICATION IN DELIVERY SERVICES

(71) Applicant: Chi Huo Song Can, Inc., Arcadia, CA (US)

(72) Inventors: Di Miao, Irvine, CA (US); Gaoyuan Li, Arcadia, CA (US)

(21) Appl. No.: 15/986,714

(22) Filed: May 22, 2018

(51) Int. Cl. G06Q 10/06; H04M 1/725; H04M 3/42; G06Q 30/06; G06Q 10/08; G06Q 30/02

(52) U.S. Cl. CPC G06Q 10/063114; H04M 1/72572; H04M 3/42221; G06Q 50/12; G06Q 10/0833; G06Q 30/0201; G06Q 30/0621

(57) ABSTRACT

The present invention involves a system and method for verifying a customer's order, without requiring a delivery service to contact the customer once the customer has placed their order with an establishment. A GUI is distributed to customer clients and delivery clients of the delivery service. The GUI is configured to connect the customer's mobile device with the establishment in order to initiate a food ordering call. The call may be routed via a server of the delivery service and seamlessly recorded. Once the customer has concluded their order with the establishment, the recorded order is communicated to a driver of the delivery service via the GUI. The GUI is configured to provide the driver with access to the recorded order. The driver may therefore verify accuracy of the order at the time of picking up the order from the establishment, ensuring an accurate order is delivered to the customer.

### TECHNICAL FIELD OF THE INVENTION

The present invention relates in general to a system and method for order verification in delivery services, and more specifically, to a system and method for enabling a delivery service to verify orders between a customer client and an establishment client.

### COPYRIGHT AND TRADEMARK NOTICE

A portion of the disclosure of this patent application may contain material that is subject to copyright protection. The owner has no objection to the facsimile reproduction by anyone of the patent documents or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Typically, ordering items, such as food, groceries or pharmaceuticals for delivery is straightforward and easy. In fact, in today's market, virtually every establishment is able to take orders via telephone, online and sometimes via mobile application. In the food industry for example, some establishments have specific web pages that list their menus and individual food items so that customers may review and either call or purchase an order directly from the website. Other establishments have specific mobile applications that enable users to do the same, and these establishments often also deliver the ordered food items to the customer after processing the order via the mobile application. Yet other establishments or businesses exclusively offer food delivery services and deliver food prepared by food establishments and thus are strictly a food delivery business. However, a problem persists in each of these various known scenarios, which has not been adequately addressed—the problem of verifying an order in an expeditious and efficient manner, especially when orders for food items are highly customizable.

For example, some service providers take orders from customers interested in food items from particular restaurants, and those service providers serve as a delivery service for the restaurant establishments selected by the customer. To ensure efficient preparation and delivery, a typical practice is to limit the menu such that only a few very specific items are offered to the public and typically customization is very limited. The problem with this approach is that customers are forced to select from a limited menu, and end up selecting a food item that is not customizable or minimally customizable. This is particularly challenging in certain cuisines in which many variations of preparing a food item are possible.

Even though facilitating each of the numerous food preparation options is desirable for the food preparation establishments and consumers alike, food delivery merchants often shy away from delivering food from certain food establishments that have a demand for highly customizable food orders, because verifying those orders may be time consuming and thus not profitable. Accordingly, it is desirable to implement a system and method that allows quick, efficient order verification means that can be practiced or employed by a food delivery service, such that food orders from all establishments can be easily and efficiently served.

Therefore, there are several problems with the current state of food delivery services that have not been adequately addressed by the prior art. The problems persist because a need to efficiently and cost-effectively verify highly customizable food orders has not been adequately met. As such, a system and method for order verification in food delivery services is desirable, and it is to these ends that the present invention has been developed.

### SUMMARY OF THE INVENTION

To minimize the limitations in the prior art, and to minimize other limitations that will be apparent upon reading and understanding the present specification, the present invention describes a system and method for order verification in food delivery services. More specifically, the present disclosure describes a system and method for enabling a food merchant or food delivery service to verify orders between a customer client and a food establishment client, by employing a graphical user interface (GUI) that may be provided to drivers of the food delivery service and customers of the food establishment.

Generally, the present invention involves a system and method for verifying a customer's order of food items to be delivered to the customer from a food establishment, without requiring a food delivery service to call or contact the customer, once the customer has placed their order with the food establishment. This system and method may be particularly useful for orders from food establishments that often require a plethora of specific and alternative instructions when preparing a food item. For example, the present invention may be useful for food delivery services that may focus particularly on delivering Asian cuisine, which is often highly modifiable, and establishments and customers alike prefer to provide specific instructions rather than selecting from a pre-arranged specific menu. In order to obviate some of the challenges of verifying that a correct order was received and thus will be delivered to the customer client correctly, a means for automatically recording the conversation between the customer client and a food establishment client is provided, whereby the recorded order is transmitted to or stored by the food delivery service in order to verify the order prior to delivering it to the customer client.

Typically, customer clients of the food delivery service may be provided with a GUI or mobile application executable by their mobile device. The GUI may be configured to, among other functions, connect the mobile device with a food establishment in order to initiate a food ordering call between the customer client and the food establishment client. The food ordering call may be routed via a server of the food delivery service provider and seamlessly recorded with the customer client's prior permission. Once the customer has concluded their order with the food establishment, the recorded order is communicated to a food delivery driver of the service provider via the GUI accessible through the driver's mobile device. In exemplary embodiments, the GUI may include a driver portal that provides the food delivery driver with customer information, including access to a media file comprising a recording of the order between the customer and the food establishment. The food delivery driver may therefore verify the exact details of the food order prior to picking up the order from the food establishment and thereby making sure that the correct food order is delivered to the customer client.

A system for verifying accuracy of a customer food order by way of a graphical user interface (GUI) distributed to a plurality of client devices, in accordance with an exemplary embodiment of the present invention, comprises: a first client device of the plurality of client devices with access to a customer portal of the GUI, the GUI configured to initiate a food ordering call between the first client device and a food establishment via one or more windows of the customer portal; a server in communication with the plurality of client devices, configured to: connect the first client device with the establishment in response to the first client device initiating the food ordering call; record the food ordering call; and provide one or more of the plurality of client devices with a recording of the food ordering call; and a second client device of the plurality of client devices with access to a driver portal of the GUI, the GUI further configured to provide the second client device with access to the recording of the food ordering call via one or more windows of the driver portal.

A method for verifying accuracy of a customer food order by way of a graphical user interface (GUI) distributed to a plurality of client devices, in accordance with practice of an exemplary embodiment of the present invention, comprises: providing a first client device of the plurality of client devices with access to a customer portal of the GUI, the GUI configured to initiate a food ordering call between the first client device and a food establishment via one or more windows of the customer portal; connecting the first client device with the establishment in response to the first client device initiating the food ordering call; recording the food ordering call; and providing one or more of the plurality of client devices with a recording of the food ordering call, including providing a second client device of the plurality of client devices with access to a driver portal of the GUI, the GUI further configured to provide the second client device with access to the recording of the food ordering call via one or more windows of the driver portal.

A system for verifying accuracy of a customer food order by way of a graphical user interface (GUI) distributed to a plurality of client devices, in accordance with yet another exemplary embodiment of the present invention, comprises: a first client device of the plurality of client devices with access to a customer portal of the GUI, the GUI configured to initiate a food ordering call between the first client device and a food establishment via one or more windows of the customer portal; a server in communication with the plurality of client devices, configured to: connect the first client device with the establishment in response to the first client device initiating the food ordering call; record the food ordering call; and provide one or more of the plurality of client devices with a recording of the food ordering call; and a second client device of the plurality of client devices with access to a driver portal of the GUI, the GUI further configured to provide the second client device with access to the recording of the food ordering call via one or more windows of the driver portal; wherein one of the one or more windows of the driver portal comprises: a first window displaying a list of selectable pending orders to be delivered to one or more users of the plurality of client devices, wherein at least one of the selectable pending orders is a selectable order associated with a user of the first client device; and a second window, launched in response to a selection of the selectable order associated with the user of the first client device, the second window displaying a media player configured to play the recording of the food ordering call; and wherein one of the one or more windows of the customer portal comprises: a first window displaying a list of selectable menus wherein at least one of the selectable menus is a selectable menu associated with the food establishment; a second window, launched in response to a selection of the selectable menu associated with the food establishment, the second window displaying a menu of the food establishment and a button configured to initiate the food ordering call between the first client device and the food establishment; and a third window for displaying an approximate location of the delivery driver of the second client device.

It is an objective of the present invention to facilitate food order verifications for food orders that may be highly customizable.

It is another objective of the present invention to efficiently verify a customer's specific order with a food establishment client.

It is yet another objective of the present invention to provide a GUI that makes the verification process seamless and efficient.

It is yet another objective of the present invention to provide a means of verifying a customer's order, without having to contact the customer once the order is placed with a food establishment client.

These and other objectives, advantages and features of the present invention are described herein with specificity so as to make the present invention understandable to one of ordinary skill in the art.

### BRIEF DESCRIPTION OF DRAWINGS

Elements in the figures have not necessarily been drawn to scale in order to enhance their clarity and improve understanding of these various elements and embodiments of the present invention. Furthermore, elements that are known to be common and well understood to those in the industry are not depicted in order to provide a clear view of the various embodiments of the invention.

FIG. 1 illustrates a system in accordance with an exemplary embodiment of the present invention.

FIG. 2 illustrates a computer-readable medium in accordance with an exemplary embodiment of the present invention.

FIG. 3 illustrates a block diagram of application functions in accordance with an exemplary embodiment of the present invention.

FIG. 4A illustrates a flow chart of a method for verifying a customer order in accordance with an exemplary embodiment of the present invention.

FIG. 4B illustrates a flow chart of a method for verifying a customer order in accordance with an exemplary embodiment of the present invention.

FIG. 4C illustrates an exemplary embodiment of data structures utilized by a system in accordance with the present invention.

FIG. 5 illustrates an exemplary screen output of a GUI for providing a customer client with menu information, in accordance with an exemplary embodiment of the present invention.

FIG. 6 illustrates an exemplary screen output of a GUI for facilitating food ordering by a customer client, in accordance with an exemplary embodiment of the present invention.

FIG. 7 illustrates an exemplary screen output of a GUI for providing location data of a delivery to a customer client, in accordance with an exemplary embodiment of the present invention.

FIG. 8 illustrates an exemplary screen output of a GUI for providing a delivery client with order information from customer clients, in accordance with an exemplary embodiment of the present invention.

FIG. 9 illustrates an exemplary screen output of a GUI for providing a delivery client with pending order information from a customer client, in accordance with an exemplary embodiment of the present invention.

FIG. 10 illustrates an exemplary screen output of a GUI for providing a delivery client with a recorded customer order, in accordance with an exemplary embodiment of the present invention.

FIG. 11 illustrates an exemplary screen output of a GUI for providing a customer client with a customer client portal facilitating signing up to a delivery service in accordance with the present invention.

FIG. 12 illustrates an exemplary screen output of a GUI for providing a customer client with a customer client portal facilitating review of available menus and ordering directly from a food establishment.

FIG. 13 illustrates an exemplary screen output of a GUI including a pop-up window or dialog box for facilitating a selection of options.

FIG. 14 illustrates an exemplary screen output of a GUI including a pop-up window or dialog box for confirming a call to a food establishment.

FIG. 15 illustrates an exemplary screen output of a GUI for providing a customer client with a customer client portal facilitating review of past and pending or in-progress orders.

FIG. 16 illustrates an exemplary screen output of a GUI for providing a customer client with a customer client portal facilitating review of a confirmed order.

FIG. 17 illustrates an exemplary screen output of a GUI for providing a delivery client with a delivery client portal facilitating signing up to a delivery service in accordance with the present invention.

FIG. 18 illustrates an exemplary screen output of a GUI for providing a delivery client with location data associated with one or more orders available to the delivery client.

FIG. 19 illustrates an exemplary screen output of a GUI for providing a delivery client with location data associated with one or more orders available to the delivery client.

FIG. 20 illustrates an exemplary screen output of a GUI for providing a delivery client with location data associated with one or more orders available to the delivery client.

FIG. 21 illustrates an exemplary screen output of a GUI for providing a delivery client with location data associated with one or more orders available to the delivery client.

FIG. 22 illustrates an exemplary screen output of a GUI for providing a delivery client with a delivery client portal facilitating review of information pertaining to orders associated with the delivery client.

FIG. 23 illustrates an exemplary screen output of a GUI for providing a delivery client with a delivery client portal facilitating confirmation of an order received by the delivery client.

FIG. 24 illustrates an exemplary screen output of a GUI for providing a delivery client with a delivery client portal facilitating confirmation of an order received by the delivery client.

FIG. 25 illustrates an exemplary screen output of a GUI for providing a delivery client with a delivery client portal a calendar tool for reviewing a status of one or more orders associated with the delivery client.

### DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized, and changes may be made, without departing from the scope of the invention. Wherever possible, the same reference numbers are used in the drawings and the following description to refer to the same or similar elements.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and or steps. Thus, such conditional language is not generally intended to imply that features, elements and or steps are in any way required for one or more embodiments, whether these features, elements and or steps are included or are to be performed in any particular embodiment.

The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present. The term “and or” means that “and” applies to some embodiments and “or” applies to some embodiments. Thus, A, B, and or C can be replaced with A, B, and C written in one sentence and A, B, or C written in another sentence. A, B, and or C means that some embodiments can include A and B, some embodiments can include A and C, some embodiments can include B and C, some embodiments can only include A, some embodiments can include only B, some embodiments can include only C, and some embodiments include A, B, and C. The term “and or” is used to avoid unnecessary redundancy.

While exemplary embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the invention or inventions disclosed herein. Accordingly, the following detailed description does not limit the disclosure. Instead, the proper scope of the disclosure is defined by the appended claims.

A primary objective of the present invention is to allow a food delivery service provider to verify that a customer's order is accurately prepared, prior to delivering the order to the customer and without requiring the delivery service provider having to contact the customer once the customer has placed their order with a food serving establishment. In order to achieve this, a GUI is distributed to mobile devices of customer clients and delivery clients of the delivery service. The GUI is configured to connect the customer's mobile device with the establishment in order to initiate a food ordering call. Accordingly, this disclosure focuses on the use of calls to place food orders that are especially intricate and typically include very specific instructions by the customer to the food establishment. As will be explained below, the call may be routed via a server of the delivery service and seamlessly recorded with the consumers prior consent. Once the customer has concluded their order with the establishment, the recorded order is communicated to a driver of the delivery service via the GUI. The GUI is configured to provide the driver with access to the recorded order. The driver may therefore verify accuracy of the order at the time of picking up the order from the establishment, ensuring an accurate order is ultimately delivered to the customer.

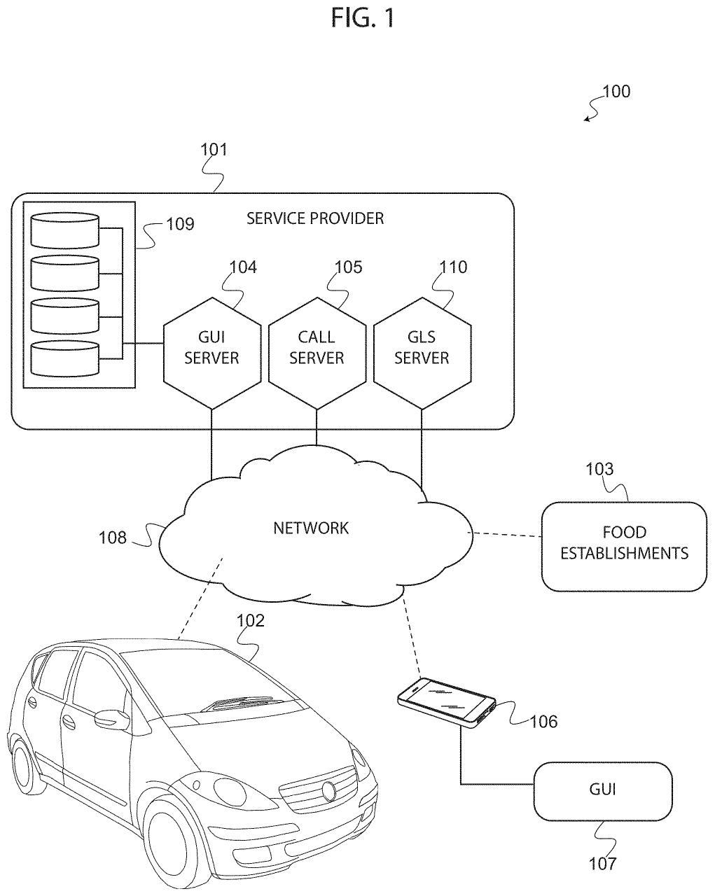

Turning now to the figures, FIG. 1 illustrates a system in accordance with an exemplary embodiment of the present invention. More specifically, FIG. 1 illustrates system 100, which includes service provider 101 managing a plurality of drivers 102 that deliver food orders to consumers from a plurality of food establishments 103. Orders placed by consumers are recorded and stored by a server 104 of service provider 101. Moreover, service provider 101 may manage more than one server such as server 105, which may exemplarily route the calls between a customer client device 106 and one or more of food establishments 103. Server 104 may host and or distribute a graphical user interface (GUI 107) to a plurality of client devices including a client device of driver 102 and customer client device 106 via network 108 such as the Internet. A database 109 of server 104 may store various profiles of client users such as delivery clients of the service provider, food establishments that have affiliated with the service provider 101 and customer clients of service provider 101.

Service provider 101 may be any type of food delivery service. For example, and without limiting the scope of the present invention, service provider 101 may be an Asian food delivery service, a general food delivery service, a grocery delivery service, a pizza delivery service, or any other type of delivery service without deviating from the scope of the present invention.

Drivers 102 are managed by service provider 101 and deliver food orders to consumers from a plurality of food establishments 103. Typically, drivers 102 are equipped with a client device (typically a smartphone) that has access to GUI 107, and more specifically access to a driver portal of GUI 107 that enables each driver 102 to review pending orders from customers. Moreover, the driver portal of the GUI 107, further discussed below, will provide drivers 102 access to recorded calls between customer clients and food establishments 103.

Food establishments 103 may comprise a plurality of food establishments or affiliates of service provider 101, who have typically engaged service provider 101 in a service arrangement and thus are listed on advertisements for their business via GUI 107. As such, food establishments 103 may include any type of food establishment without deviating from the scope of the present invention including for example Asian cuisine establishments.

Server 104 of service provider 101 is typically configured to provide a plurality of client devices with a GUI such as a mobile application, and or host the GUI as well as manage all orders and deliveries of system 100. Server 104 may store profiles for drivers 102, profiles for customer clients (including a user of client device 106) and store information concerning each of the affiliated food establishments 103 including but not limited to contact information and location information for each driver, contact information and location information for each customer, and contact information addresses and menus for each food establishment. Of course, other servers, including third-party servers may be employed without deviating from the scope of the present invention. For example, a server may be dedicated to handle orders, another server may be employed to exclusively handle location services for client devices of drivers 102, and yet another server may be employed for handling calls between client devices of customers such as client device 106 and food establishments 103. In the exemplary embodiment shown in FIG. 1, service provider 101 employs server 105 for handling such calls

Server 105 may be configured to connect client device 106 with at least one of food establishments 103 in response to client device 106 initiating a food ordering call. As will be explained further below, a customer portal may be provided to customer clients that enable seamless call for recording the call between the customer and the food establishment. Typically, once a call is initiated from client device 106, server 105 records the food ordering call. The food ordering call is then made accessible to one or more drivers that may be assigned to deliver that particular order by providing one or more of the plurality of client devices with a recording of the food ordering call via the driver portal of the GUI.

As such, one or more servers may manage several aspects of system 100. For example, and without deviating from the scope of the present invention, a GUI server 104 may be dedicated to services such as web GUI services or mobile application services. A geographic location services server or GLS server 110 may be implemented for providing geographic location services. For example, GLS server 110 may facilitate identifying driver locations, establishment locations as well as helping the drivers find their delivery destinations. A GUI server 104 may be implemented to handle the various requests for information, as well as overseeing transactions of the food orders that are purchased via system 100. Naturally, system 100 may be configured to perform its tasks with multiple servers or a single server without deviating from the scope of the present invention; in the exemplary embodiment shown in FIG. 1, service provider 101 employs server 110 for handling geographic location services.

Client device 106 may be a mobile device or smartphone. Naturally, client device 106 may be a desktop computer, a tablet, a smartphone, or any other device suitable for running GUI 107. Client device 106 is typically controlled by a customer client of service provider 101 for accessing a customer client portal of GUI 107, by which the customer or user of client device 106 may find or discover one of a plurality of food establishments 103 from which to make a food order. As will be explained further below, a customer may be presented with one or more windows or screens via GUI 107 in order to present menu information as well as facilitate making a call directly to the food establishment of their choice.

GUI 107 is an application or software such as a desktop application, a mobile application, a browser suitable for accessing a website, or any other suitable software for accessing a GUI in accordance with the present invention. In exemplary embodiments, GUI 107 is provided to both delivery clients and customer clients via a single mobile application having different portals for the two types of users. That is, in exemplary embodiments, GUI 107 may include a customer portal configured to facilitate the initiating of a food ordering call between client device 106 and one of food establishments 103 via one or more windows displayed to the user.

For example, a window or screen output of the GUI, and more specifically via the customer portal of the GUI, may display a list of selectable menus wherein at least one of the selectable menus is a selectable menu associated with one of the food establishment 103. Moreover, another window or screen output of the GUI, and more specifically a window provided via the customer portal of the GUI may display a menu of a selected food establishment along with a button configured to initiate the food ordering call between client device 106 and food establishment 103. Other features and functionalities may be provided to customer users such as searchable food categories and searchable restaurant or food establishment lists of affiliates of service provider 101. Furthermore, via one of the one or more windows of the customer portal a window or screen output of the GUI may be provided for displaying an approximate location of the delivery driver once the customer has ordered their order.

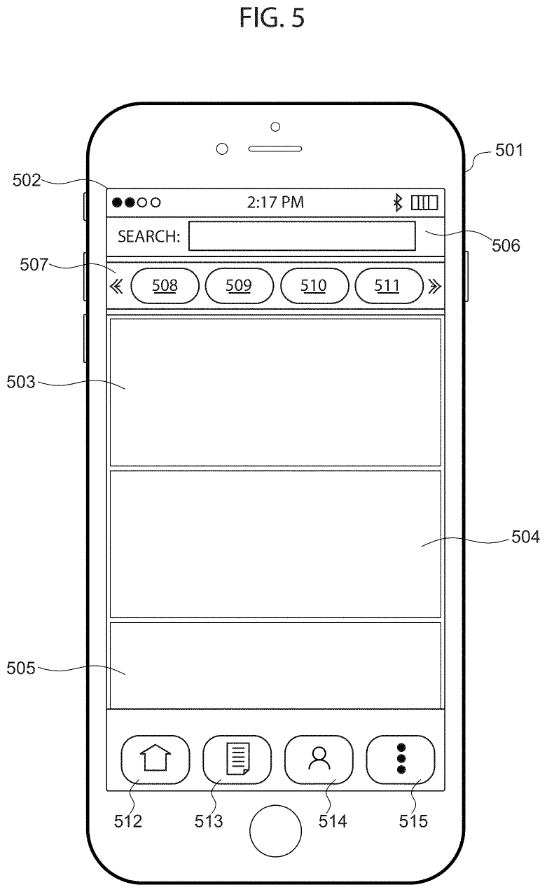

In exemplary embodiments employing different portals for drivers than customers, GUI 107 may include a driver portal for drivers 102 of service provider 101, wherein the driver portal is configured to provide a client device of each of drivers 102 with access to the recording of the food ordering call recorded via server 105. One of the one or more windows of the driver portal may comprise a window or screen output of the GUI displaying a list of selectable pending orders to be delivered to one or more users of the plurality of client devices such as client device 106, wherein at least one of the selectable pending orders is a selectable order associated with a user of client device 106. As will be discussed further below, in exemplary embodiments, a window or screen output of the GUI may display a media player configured to play a recording of the food ordering call associated with the order from client device 106. Moreover, the driver portal may display other information such as but not limited to customer information of the user of the client device 106 including address information, name and order information in text format. Furthermore, functionality such as call buttons and other functionality may be presented to the driver via the driver portal, and specifically in a same window or screen output of GUI 107, such as a button for launching directions to an address associated with the user of client device 106, and another button for launching directions to an address associated with the food establishment from which the customer made their order. These functionalities aid the driver in finding each location and successfully completing their assigned food deliveries. Below, with reference to FIG. 5-FIG. 10, several exemplary screen outputs or windows of a GUI in accordance with the present invention are discussed, including various functionalities that may be offered therein.

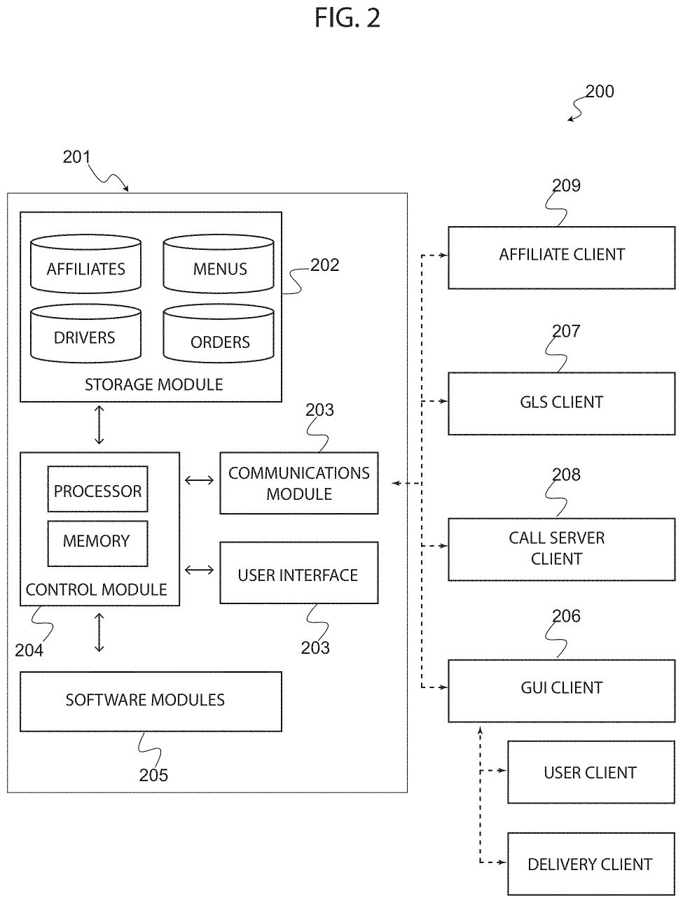

Turning now to the next figure, FIG. 2 illustrates a computer-readable medium for verifying accuracy of a customer food order by way of a graphical user interface (GUI) distributed to a plurality of client devices, in accordance with one embodiment of the present invention. More specifically, FIG. 2 illustrates a block diagram of server 201, which includes storage module 202, communications module 203, control module 204 and software module 205. Moreover, server 201 includes GUI client 206, GLS client 207, call server client 208, and affiliate client 209.

In an exemplary embodiment, server 201 may comprise a two-tier server setup with one database layer and one application (web server) layer. This may allow the system to scale user-wise by load balancing the application layer and also provide increased security. A cloud-based system may run on servers in the Amazon Virtual Private Cloud environment. All physical documents as well as database backups may be encrypted and stored in Amazon's Simple Storage Service (S3). For disaster recovery purposes the system may implement a backup of all current layer images stored in S3 and backups of the database performed incrementally every X minutes and full daily backups. For high availability (and also disaster recovery) purposes based on the service provider's requirements, the system may address failover clustering the database server as well. All security and firewalls may be configured using best practices and industry standard methods. Access to servers may be limited and monitored. All system access attempts (success or failure) may be logged in the database and physical log files as well as access to any base entities.

In other embodiments, server 201 may be a distributed server system set up for robustness in case one server fails. In such exemplary embodiment, server 201 is a World Wide Web (WWW) server connected to the internet. Server 201 may comprise representational state transfer (REST) architecture. Although other architectures may be implemented, a REST server may be desirable to maximize efficiency, particularly in systems that may experience an increasing number of requests. Furthermore, similar architectures may provide a centralized means of connecting with other system components such as third-party applications or websites that may provide services including websites or mobile device applications and geographic location services. Server 201 may comprise of a plurality of distributed servers configured for fault tolerance, duplication and backup capabilities.

Naturally, server 201 may be configured with any known techniques and in any known manner to achieve a desired security and functionality. Whatever architecture, technique or manner in which server 201 is implemented, server 201 is typically configured to: provide a first client device of the plurality of client devices with access to a customer portal of the GUI, the GUI configured to initiate a food ordering call between the first client device and a food establishment via one or more windows of the customer portal; connect the first client device with the establishment in response to the first client device initiating the food ordering call; record the food ordering call; and provide one or more of the plurality of client devices with a recording of the food ordering call, including providing a second client device of the plurality of client devices with access to a driver portal of the GUI, the GUI further configured to provide the second client device with access to the recording of the food ordering call via one or more windows of the driver portal.

In some embodiments, a GLS client may facilitate server 201 with implementing geographic location services. For example, and without limiting the scope of the present invention, server 201 may be further configured to match a geographic location relevant to a customer with the geographic location associated with a food establishment chain from affiliates of the service provider, in order to provide that customer only with menus served in a particular geographic region, which the customer may have selected. In alternative embodiments, server 201 may be further configured to match a geographic location of a client device of a customer with the geographic location associated with a selected food category or cuisine type in order to display on a client device only those types of menus from food establishments in the vicinity of that customer's device. As may be appreciated, different variations of location-based services may be incorporated without deviating from the scope of the present invention.

Storage module 202 may be coupled either externally or internally to server 201. For example, storage module 202 may be one or more long term memory storage devices, such as a hard drive, disk drive, tape unit, Network Attached Storage (NAS) device, Storage Attached Network (SAN) device, RAID disk array, or optical disk array. Although typically a long-term memory storage device, storage module 202 may be any other memory device without departing from the scope of the present invention. In an exemplary embodiment, storage module 202 is striped across redundant storage containers or RAID disk array in a SAN environment for increased data access speeds and robustness. Of course, any other storage configuration would not deviate from the scope of the present invention so long as storage 202 is suitable for the needs of server 201. In one exemplary embodiment, storage module 202 is a cloud-based storage solution suitable to host one or more databases for the system managed by server 201.

Storage module 202 may hold multiple databases containing data objects within data repositories collected by server 201. The databases of storage module 202 may be created by a known database manager using known technologies such as relational architecture and SQL access, such as Microsoft™ SQL or Oracle™ DB. However, the database of storage module 202 may be as simple as a series of files stored in a directory, with a text file listing several filename locations without departing from the scope of the present invention. In one embodiment, the one or more databases of storage module 202 may be a combination of a known database manager, and an organized directory tree structure, wherein the database manager stores text information in the database itself, but stores multimedia information and other non-text information such as filename locations of files stored in an organized directory tree structure.

In an embodiment in which server 201 relies on cloud computing, storage module 202 may include technologies offered by Amazon™ such as Amazon™ Elastic Compute Cloud (AWS EC2), whereby storage module 202 may employ MySQL™ and AWS EC2™ instances.

The one or more databases of storage module 202 may hold multiple data repositories corresponding to: affiliates of the service provider including a list of food establishments that may be in a contractual relationship with or otherwise working in conjunction with or being served by the food delivery service provider that manages server 201; a plurality of menus including food items that may be available from the various affiliates of the service provider; a plurality of profiles of food delivery drivers, or delivery clients, that may be associated with or employed by the food delivery service provider that manages server 201; a plurality of profiles of customers, or customer clients, that may sign up with services such as for use of the mobile application provided by the food delivery service provider that manages server 201; orders and or list of all transactions that may be generated between customer clients and affiliates and which are delivered by delivery clients; and any other useful information that may be required or preferably stored for purposes of managing server 201 and or the service provider's business.

Communications module 203 may be implemented as a single device or multiple devices configured to connect server 201 to a network such as the internet, and or communicate server 201 to other system components, including other servers such as web servers, mobile device application servers, and/or a geographic location services server.

Control module 204 typically includes one or more processors and memory configured to execute a set of one or more executable instructions such as program code and/or data stored on one or more computer readable mediums to implement the various applications, data, steps described below and any other instructions pertinent to the functions of server 201. For example, such executable instructions may be included in software module 205.

Software module 205 may include one or more modules for the various functions of the system managed by server 201. For example, and without limiting the scope of the present invention, software module 205 may include a food delivery dispatch module for dispatching food deliveries requested by orders received from the service provider's affiliates or other software modules that may help create, track and monitor orders and deliveries served by the service provider.

Server 201 may include various clients, such GUI client 206, GLS client 207, call server client 208, and affiliate client 209. These clients may include hardware components and software components configured to communicate with server 201 in order to receive requests from client devices, use location-based methods to provide relevant records, handle the various requests for information, as well as oversee transactions of the food orders that are purchased via server 201.

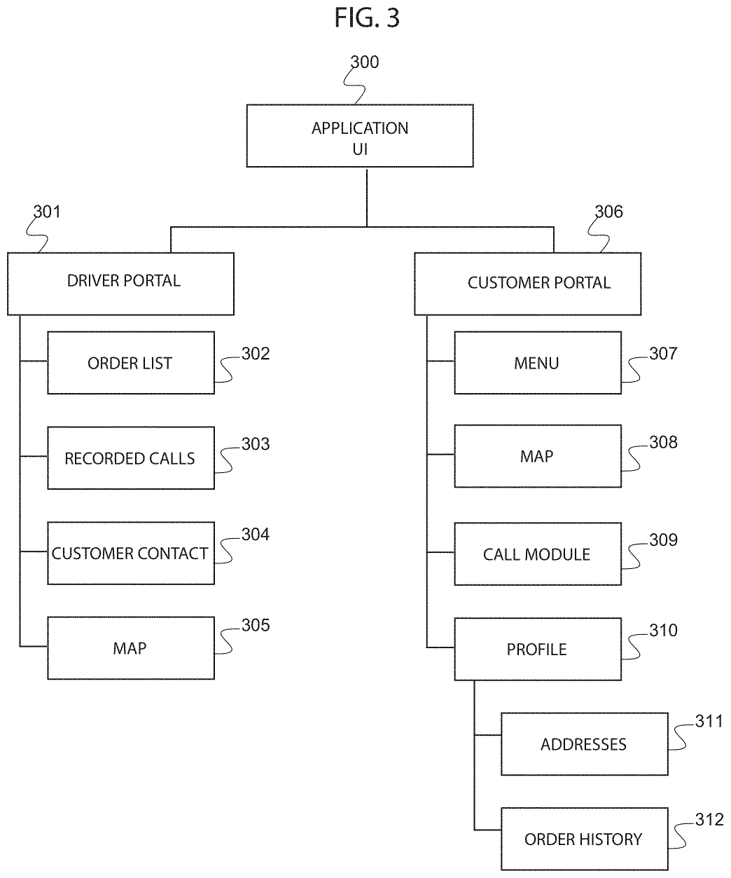

Turning now to the next figure, FIG. 3 illustrates a block diagram of application functions in accordance with an exemplary embodiment of the present invention. More specifically, FIG. 3 depicts application user interface 300, which may typically be a web application or mobile application that provides a GUI to delivery clients and customer clients of the service provider. Although different applications such as distinct mobile applications may be provided to each of delivery clients and customer clients, in an exemplary embodiment, application 300 may include separate hubs or portals that provide each type of user client with dedicated functionality for the particular type of user.

For example, and without limiting the scope of the present invention, application 300 may include a delivery client portal or driver portal 301 on which a delivery client, such as a food delivery driver of the service provider, may find functionalities that: help the driver locate a pending order; review and listen to recorded information concerning the order, including verifying the accuracy of an order by listening to a recorded call between a customer and a food establishment; and generally facilitate completing delivery of the ordered food to the intended customer.

Similarly, and without limiting the scope of the present invention, application 300 may include a customer client portal 306 on which a customer client, such as a customer interested in ordering a food item from a menu offered via application 300, may find functionalities that: help the customer locate a convenient or suitable food establishment; review information concerning the food establishment and menu offered by the same; initiate a call between the customer and the selected food establishment; track via geo-location means a pending food delivery associated with their order; and generally facilitate completing an order for food items.

In the exemplary embodiment illustrated in FIG. 3, driver portal 301 may provide an order list 302, a list of recorded calls 303 associated with one or more pending orders for the driver to pick up and deliver, customer contact information 304 including a means of communicating with a customer if necessary, and a navigational tool or map 305 to aid the delivery client to navigate to and in between the food establishment and the customer's order drop-off location.

In the exemplary embodiment illustrated in FIG. 3, customer portal 306 may provide a menu list 307, a tracking tool or map 308 including a geo-location means of tracking a pending food delivery associated with their order, a call module 309 for directly making calls to a selected food establishment, whereby calls may be routed to a server of or affiliated with the service provider that records the calls concerning food orders, and a profile module 310 for gathering customer data. In exemplary embodiments, profile module 310 may be configured to store a set number of addresses to which the customer may want a delivery sent to. Moreover, the customer may be provided with a means to view an order history 312 in case a customer wants to re-order a similar item on a future order.

Of course, the functionalities mentioned above are not limited to each designated portal and some or all of the features and functionalities provided via a delivery client portal may be provided to a customer client via customer portal without deviating from the scope of the present invention. In exemplary embodiments, only the delivery clients have access to a customer's recorded call. In other embodiments customers may have access to the recorded calls as well. In exemplary embodiments, driver portal 301, may include a similar profile module for delivery clients in order for the service provider to keep accurate up-to-date records of their drivers.

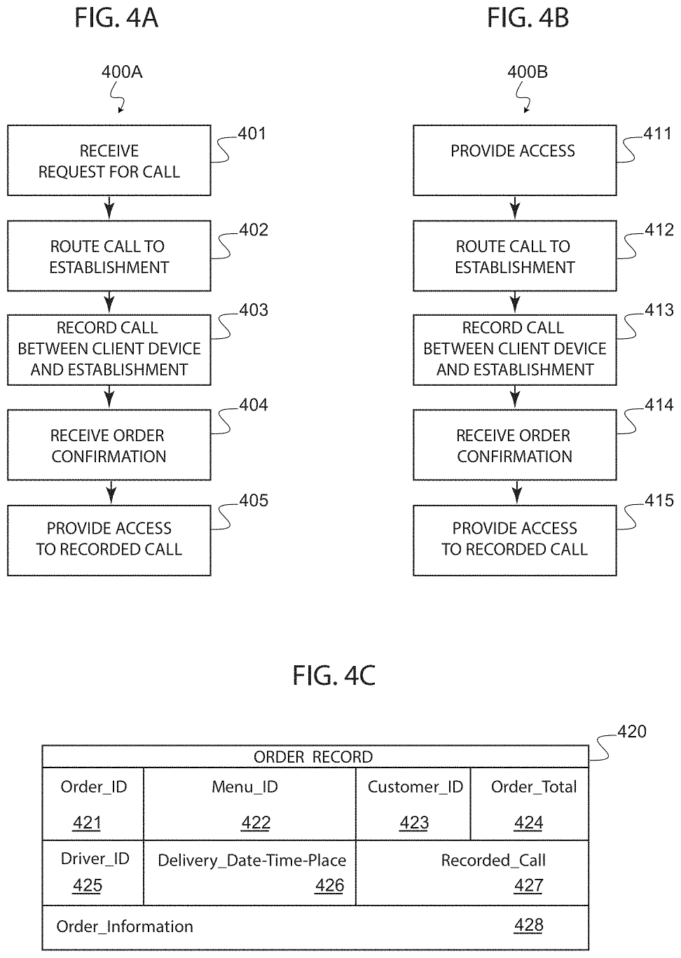

Turning now to the next figure, FIG. 4A illustrates a flow chart of a method for verifying a customer order in accordance with an exemplary embodiment of the present invention. More specifically, FIG. 4A depicts method 400A; although method 400A is shown in a particular sequence of steps, other conceivable sequence of the steps may be practiced without deviating from the scope of the present invention.

In an exemplary embodiment, method 400 comprises: step 401, including receiving a request for a call; step 402, including routing the call to a food establishment; step 403, including recording the call between the customer and the food establishment; step 404, including receiving an order confirmation from the food establishment; and step 405, including providing access to the recorded call to a delivery client assigned to complete a delivery for the confirmed order.

In step 401, a request for a call may be received by one or more servers of the service provider. For example, a call may be initiated via a client device of the customer client by the user of the client device selecting a button, text or image provided via the GUI associated with a telephone number for a food establishment that the customer has selected via a GUI screen. In exemplary embodiments, a button with the words “CALL” may be provided via a touch screen so that the client can easily ‘press’ the button and initiate the call.

In step 402, the call may be received by the appropriate server and routed to the corresponding food establishment such that the customer client is seamlessly connected with the targeted food establishment through the appropriate server of the service provider.

In step 403, the call between the customer and the food establishment is recorded and a media file of the recorded call is stored at the appropriate server.

In step 404, an order confirmation from the food establishment may be received. In some embodiments this step may not be necessary, however in exemplary embodiments, it may be desirable for the food establishment to confirm that the order has been received and is being prepared prior to the service provider assigning a delivery client to pick up and deliver the food order to the intended customer.

In step 405, access to the recorded call is provided to a delivery client assigned to complete a confirmed delivery. This step may include sending the pending order to a single client device of a delivery driver. Alternatively, this step may include making the pending order available to a plurality of delivery clients and allowing a delivery client to select the order on a first come, first served basis.

In an exemplary embodiment, once access to a recorded call of a client is provided and an order is assigned to a delivery client, the driver with access to the recorded call may proceed to the food establishment to pick up the order and deliver it to the customer client.

Turning now to the next figure, FIG. 4B illustrates a flow chart of a method for verifying a customer order in accordance with an exemplary embodiment of the present invention. More specifically, FIG. 4B depicts method 400B, performed by a server and a plurality of client devices, for verifying accuracy of a customer food order by way of a graphical user interface (GUI) distributed to the plurality of client devices. Although method 400B is shown in a particular sequence of steps, any other conceivable sequence of the steps may be practiced without deviating from the scope of the present invention.

In an exemplary embodiment, method 400B comprises: step 411, including providing a first client device of the plurality of client devices with access to a customer portal of the GUI, the GUI configured to initiate a food ordering call between the first client device and a food establishment via one or more windows of the customer portal; step 412, including connecting the first client device with the establishment in response to the first client device initiating the food ordering call; step 413, including recording the food ordering call; step 414, including providing one or more of the plurality of client devices with a recording of the food ordering call; and step 415, including providing a second client device of the plurality of client devices with access to a driver portal of the GUI, the GUI further configured to provide the second client device with access to the recording of the food ordering call via one or more windows of the driver portal.

In step 411, a first client device of the plurality of client devices is provided with access to a customer portal of the GUI, the GUI configured to initiate a food ordering call between the first client device and a food establishment via one or more windows of the customer portal. In this step, the GUI may further provide a pop-up window, a notice or notification screen or any other means of notifying the customer client that the call being initiated will be recorded to ensure accuracy of the order.

In step 412, the first client device is connected with the establishment in response to the first client device initiating the food ordering call. As mentioned above this may be provided through a server of the service provider or a third-party server affiliated with the server provider.

In step 413, the food ordering call is recorded. In exemplary embodiments, a media file of the recorded call is stored at the appropriate server.

In step 414, one or more of the plurality of client devices is provided with a recording of the food ordering call. This step may include generating an order record including a media file of the recorded call and making that order record exclusively available to a single client device of a delivery driver. Alternatively, this step may include sending the order record simultaneously to a plurality of delivery clients and allowing a delivery client to select the order on a first come, first served basis.

In step 415, a second client device of the plurality of client devices is provided with access to a driver portal of the GUI, the GUI further configured to provide the second client device with access to the recording of the food ordering call via one or more windows of the driver portal.

Turning now to FIG. 4C, several exemplary embodiments of data structures utilized by a system in accordance with the present invention are illustrated. More specifically, FIG. 4C exemplarily illustrates embodiments of data structures for an order record, which includes but is not limited to an order ID 421, a menu ID 422, a customer ID 423 an order price total 424, a driver ID 425, a delivery date, time and place record 426 a recorded call media file 427 and general order information 428. A system in accordance with the present invention may use such data structures to generate different screen outputs such as but not limited to screen 1001 described below. The information for order record 420 may be retrieved by a server and the record generated accordingly. For example, and without limiting the scope of the present invention, this information may be acquired during the sign in process of drivers, consumers and affiliates alike. When a consumer has signed up and creates an order, the system may generate the record for use as the order is assigned to a driver and later delivered to a particular customer.

Order ID 421 may be any number or alphanumeric reference to identify a particular order that requires delivery or has been assigned to a delivery client for delivery to a customer.

Menu ID 422 may be any number or alphanumeric reference to identify a particular menu that is provided via the GUI. This may aid the service provider in identifying the source of the order. Certain information may be assigned or associated with Menu ID 422 including but not limited to an address and identification of the food establishment from which a customer may have selected food items for an order.

Customer ID 423 may be any number or alphanumeric reference to identify a particular customer that has signed up or logged in to the mobile application provided by the service provider. As with a Menu ID 422, certain information may be assigned or associated with Customer ID 423 including but not limited to an address and identification of the customer such as a name, preferred delivery address or selected address for delivery.

Order price total 424 may be an indicator or value associated with the total amount paid by the customer or an amount associated with a percentage of the order to which the service provider is entitled to.

Driver ID 425, may be any number or alphanumeric reference to identify a particular delivery client such as a driver's name and vehicle information and or any other information that a service provider may request or require from a driver.

Delivery date, time and place record 426 may be an indicator of the date, time and place for a particular order.

Recorded call media file 427 may be a file such as an mp3 file or any other type of media file, or even a link to a file that allows a delivery client to listen to a recorded call recorded by a server of or affiliated with the service provider.

General order information 428 may simply include notes, comments or any other pertinent information that may be required or useful to the service provider, including but not limited to any notes that may be provided to the driver in order to facilitate delivery of the order subject of order record 420.

Turning now to the next figure, FIG. 5 illustrates an exemplary screen output of a GUI for providing a customer client with menu information, in accordance with an exemplary embodiment of the present invention. More specifically, FIG. 5 illustrates an exemplary screen output or window for a GUI configured for a customer client or delivery client, in accordance with one embodiment of the present invention. In exemplary embodiments, this window may serve as a landing page or main control page that offers a gateway to menus or sub-menus for the various functionalities available to a customer, including but not limited to searching for a food establishment from which the customer client may order food from. In the depicted embodiment of FIG. 5, client device 501 is a mobile device or smartphone. Naturally, client device 501 may be a desktop computer, a tablet, a smartphone, or any other device suitable for running a GUI such as a desktop application, a mobile application, a browser suitable for accessing a website or any other suitable software for accessing a GUI in accordance with the present invention.

Typically, client device 501 runs a GUI that includes a touch-screen interface that includes screen 502, which may display a start-screen, landing page or dashboard. In such exemplary embodiment, the GUI may provide various data objects such as tabs, buttons or navigation tools.

Screen 502 includes a scrolling display of tabs 503, 504 and 505 which may correspond to different food establishments. Accordingly, a user may scroll up and down and view other additional tabs to discover additional food establishments that are affiliated with the service provider and thus available for ordering. Each of the tabs 503, 504 and 505 may include information such as the name of the food establishments associated with the tab as well as images or pictures of their cuisine.

In order to offer searchable means of selecting a food establishment, screen 502 may further include a text search box 506, which enables a customer client to quickly search for a name of a food establishment and or a category of food, a type of cuisine or favorite dish.

Similarly, a carousel 507 including several categories may be provided including virtual buttons 508, 509, 510 and 511. Each of these buttons may comprise images for displaying a variety of food categories that have been pre-selected by the service provider. In exemplary embodiments, a user may swipe bidirectionally to select from a plurality of categories by selecting one of the buttons visible on screen 502.

In the shown embodiment, navigation tools may include a set of virtual buttons 512, 513, 514 and 515. Button 512 may be a home button that allows a user to navigate back to screen 502 from anywhere on the application. Button 513 provide a list of pending orders (for delivery clients) or a list of prior orders (for customer clients), without limiting the scope of the present invention. Button 514 may launch a profile page in which a user (either a driver user or a customer user) may provide contact information. For example, and without limiting the scope of the present invention, a delivery client may provide certain information in their profile such as their contact information, driver's license, vehicle make and model, vehicle license plate and or any other information that the service provider may find useful and or may share with customers—such as for example the name of the driver, and make and model of the vehicle that will be delivering the order to the customer.

Similarly, and without limiting the scope of the present invention, a customer client may provide certain information in their profile such as their contact information, phone number and one or more addresses to which they prefer items be delivered to. In an exemplary embodiment, a customer client may include up to three addresses to which food may be delivered. Moreover, in exemplary embodiments such profiles may be easily updated and edited by each user as required.

Button 515 may include access to a settings or control menu hub, which may enable each user to indicate their user type. For example, a customer client may indicate that they are signing up as a customer, while a delivery driver for the service provider may indicate that they are signing up to use the GUI as a driver. This may be desirable to control permissions of which hub or portal a user may be provided access to. For example, in exemplary embodiments, customer clients are not given access to their recorded calls with food establishments and thus a screen displaying that functionality will be limited to driver users that have authorization to use the driver portal of the GUI.

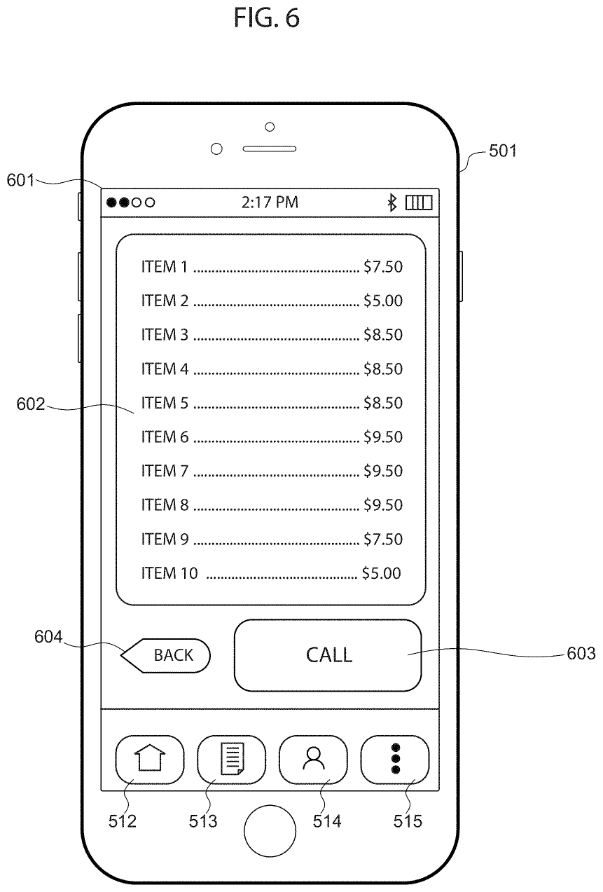

Turning now to the next figure, FIG. 6 illustrates an exemplary screen output of a GUI for facilitating food ordering by a customer client, in accordance with an exemplary embodiment of the present invention. More specifically, FIG. 6 depicts a screen output or window 601 that may be generated by the GUI once a customer client has selected a food establishment from, for example one of selectable tabs 503, 504, 505 or any other selectable tab that the user may have scrolled to, searched for or otherwise found via screen 502.

Screen 601 may provide a menu 602 including food and drink items from a selected food establishment. Moreover screen 602 may include a call button 603 for calling the selected food establishment and making an order. As mentioned above, upon pressing call button 603 client device 501 may initiate a food ordering call between the customer and the selected food establishment. In exemplary embodiments, the GUI may further provide a pop-up window, a notice or notification screen or any other means of notifying the customer client that the call being initiated will be recorded to ensure accuracy of the order.

To facilitate navigation, a simple back button 604 may be provided allowing a user to navigate back to the last page rather than go directly to the home page; this may be useful when a customer user has arrived at screen 601 from a previous search result page that may be provided by the GUI.

Upon making the call, and either providing payment through the GUI or otherwise confirming a purchase of the order with the food establishment, an option may be provided for a customer user to see a status of their delivery. As such, the next figure depicts a screen for providing location data to a delivery customer.

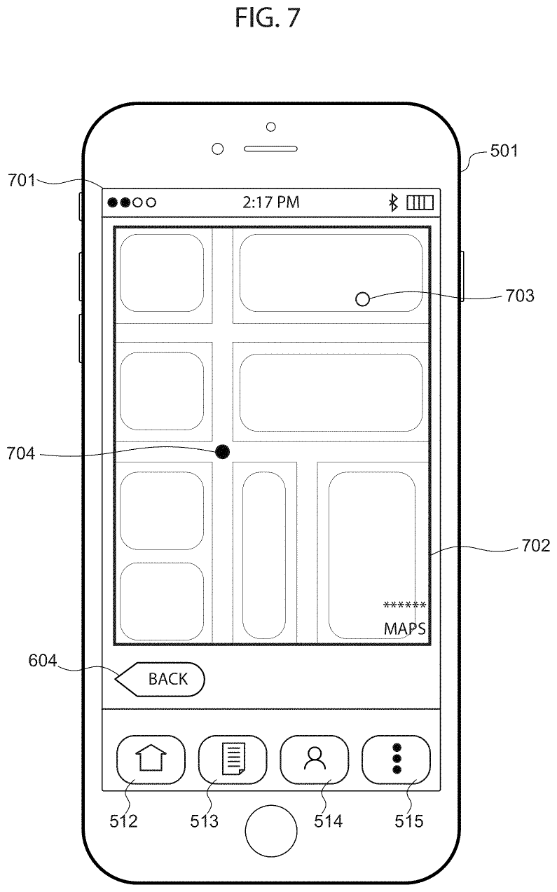

Turning now to FIG. 7, an exemplary screen output of a GUI for providing location data of a delivery to a customer client, in accordance with an exemplary embodiment of the present invention is illustrated. More specifically, FIG. 7 depicts screen 701 displaying a map 702 that shows the customer user relevant location data such as, for example and without limiting the scope of the present invention, their own location 703 and the location of the delivery driver 704. As will be appreciated by a person of ordinary skill in the art, such geo-location services may be performed with known technologies and by known means using a third-party service or otherwise implementing the known technologies with a server of the service provider.

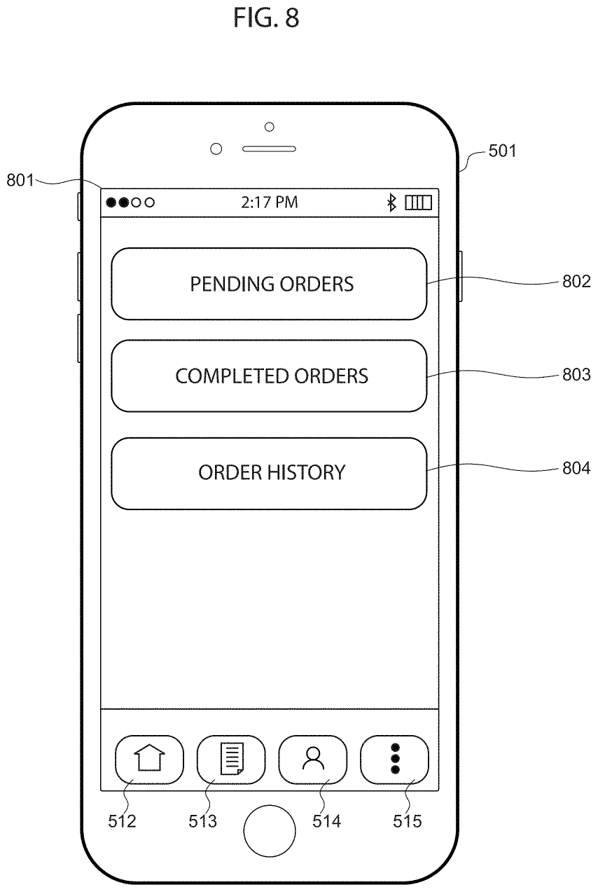

Turning now to the next figure, FIG. 8 illustrates an exemplary screen output of a GUI for providing a delivery client with order information from customer clients, in accordance with an exemplary embodiment of the present invention. More specifically, screen 801 may be a screen that is provided exclusively to delivery clients of the GUI.

Screen 801 may include, without limiting the scope of the present invention, a variety of tabs that help a driver navigate through the various functionalities of the driver's hub or driver portal of the GUI. In the shown embodiment, screen 801 includes tabs 802, 803 and 804.

Tab 802 may navigate a delivery client to a list of pending orders, such as will be discussed below with reference to the next figure. Tab 803 may navigate the delivery client to a list of completed orders. And tab 804 may navigate the delivery client to an order history including all orders.

As mentioned above, selecting tab 802 may navigate the delivery client to a pending orders list or screen 901 discussed in turn.

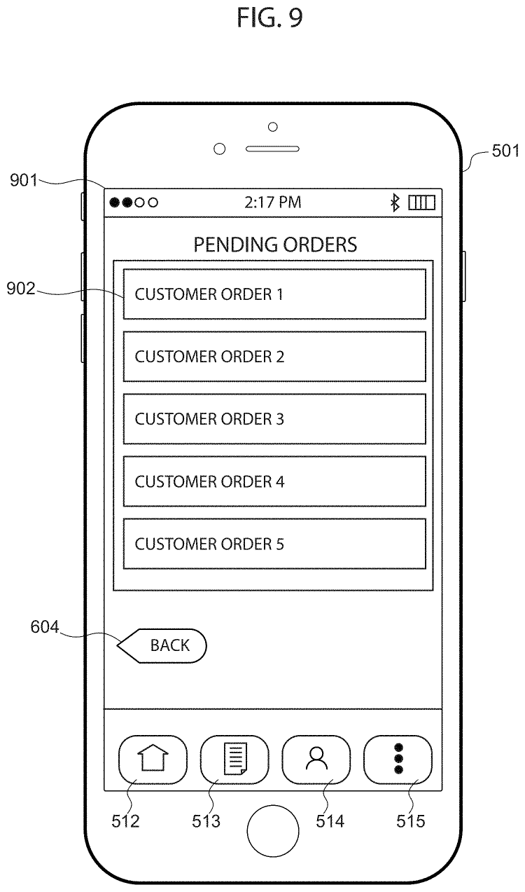

FIG. 9 illustrates an exemplary screen output of a GUI for providing a delivery client with pending order information from one or more customer clients, in accordance with an exemplary embodiment of the present invention. More specifically, screen 901 is shown including a list of pending orders such as pending order 902. In exemplary embodiments, a delivery client could navigate through this list to see what pending orders are available for delivery. In some exemplary embodiments the delivery client can use this list to select an order to serve—for example, and without limiting the scope of the present invention, a driver may select an order depending on their proximity to the food establishment. In other embodiments, the delivery client may simply view the orders and use the list to track their progress throughout their work day.

Selecting an order may, for example, take the delivery client to a screen from which order details regarding the ordering customer and including a recorded call between the customer and the food establishment may be accessed. Such screen is depicted in the embodiment of the following figure.

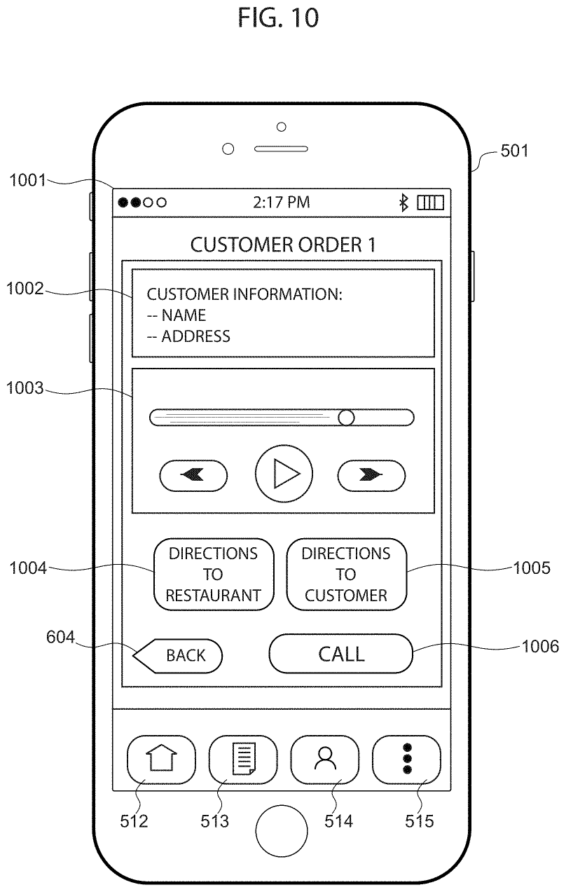

FIG. 10 illustrates an exemplary screen output of a GUI for providing a delivery client with a customer order record, in accordance with an exemplary embodiment of the present invention. When a customer makes an order from a food establishment, an order record may be generated. The order record may include, but is not limited to, a media file with the recorded call. Accordingly, this order record may be provided to the delivery client via a screen of a delivery client portal of the GUI, such as screen 1001.

In such exemplary embodiment, screen 1001 may include information from an order record such as order record 420, including order ID 421, a menu ID 422, a customer ID 423 an order price total 424, a driver ID 425, a delivery date, time and place record 426 a recorded call media file 427 and general order information 428. When provided to a driver via screen 1001, however, this information may be presented as customer information tab 1002 and media player 1003. Moreover, tabs or buttons such as buttons 1004 and 1005 may provide the delivery client to a navigational tool such as a map with direction instructions.

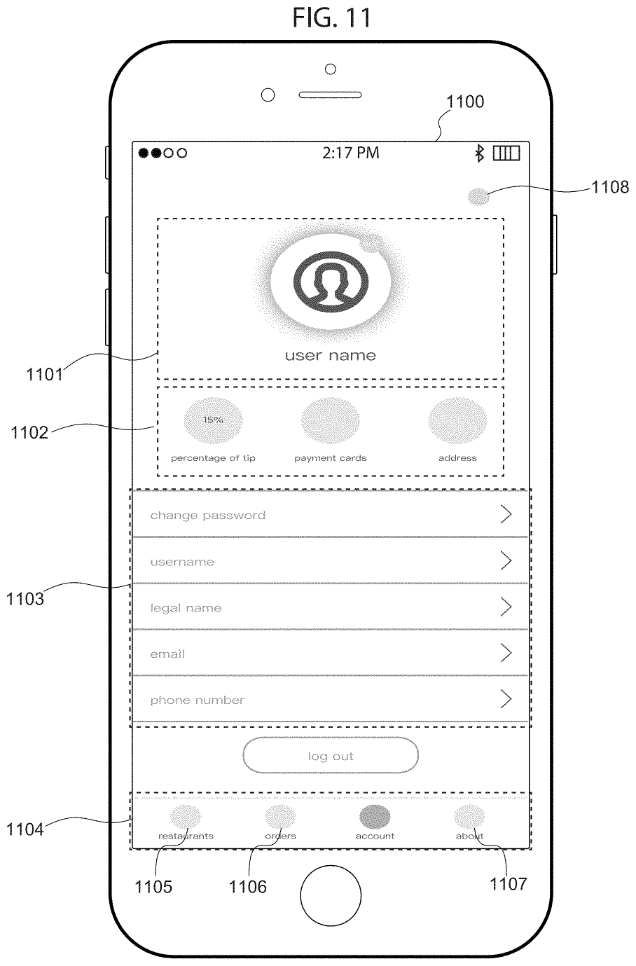

Turning now to the next set of figures, FIG. 11-FIG. 16 illustrate exemplary screen outputs of a GUI employing a customer client portal in accordance with the present invention.

FIG. 11 illustrates an exemplary screen output of a GUI for providing a customer client with a customer client portal facilitating signing up to a delivery service in accordance with the present invention. More specifically, in exemplary embodiments, a screen 1100 may display a variety of data entry fields for receiving information from a user that is interested in the service provider's services such as food delivery services. Without limiting the scope of the present invention, screen 1100 may include field 1101 for including an image associated with the customer; this may include an image upload function or the like. Similarly, fields 1103 may request basic information such as name, username and password selection. Field 1102 may include a plurality of tools for including preset information such as credit card information, delivery address information and or a set, preselected or selectable tip amount that may be chosen by the customer client to be used with future orders. Moreover, a navigational tool 1104 may be implemented to help a customer client navigate through the various screens provided by the GUI. This may include, without limitation and only by way of example: a restaurant button 1105 linking the user to a list of restaurants serviced by the service provider; an order button 1106 for reviewing in-progress or past orders by the customer client; an account button linking the user to an accounts page where the user may manage their account including, for example, their delivery address and credit cards; and an about button 1107 linking the user to an information page. A help button 1108 may be implemented as well to contact the user with customer services, an FAQ section or other useful information that may be made available to the customer client.

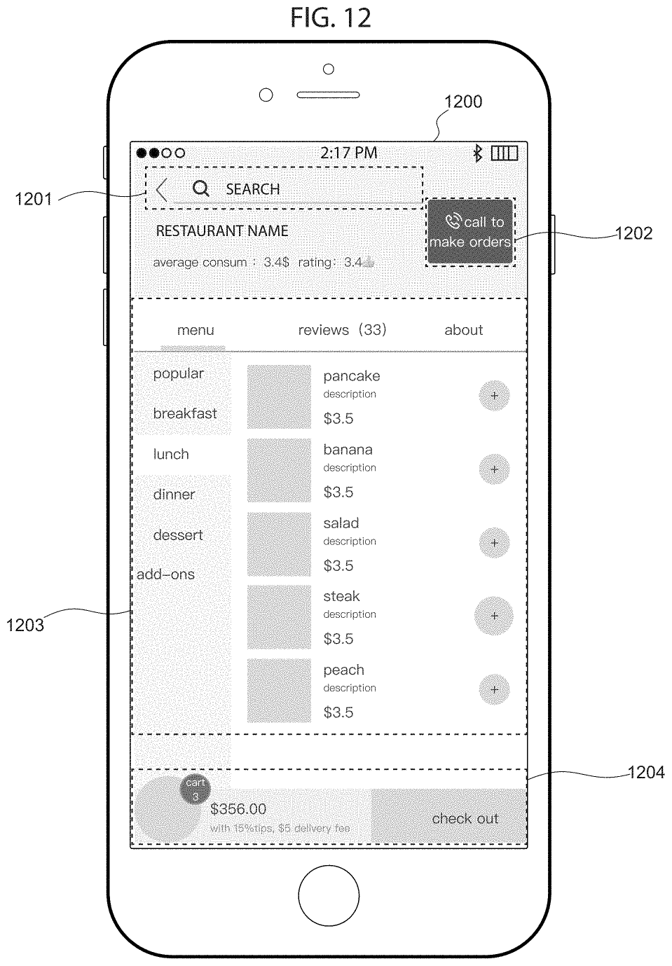

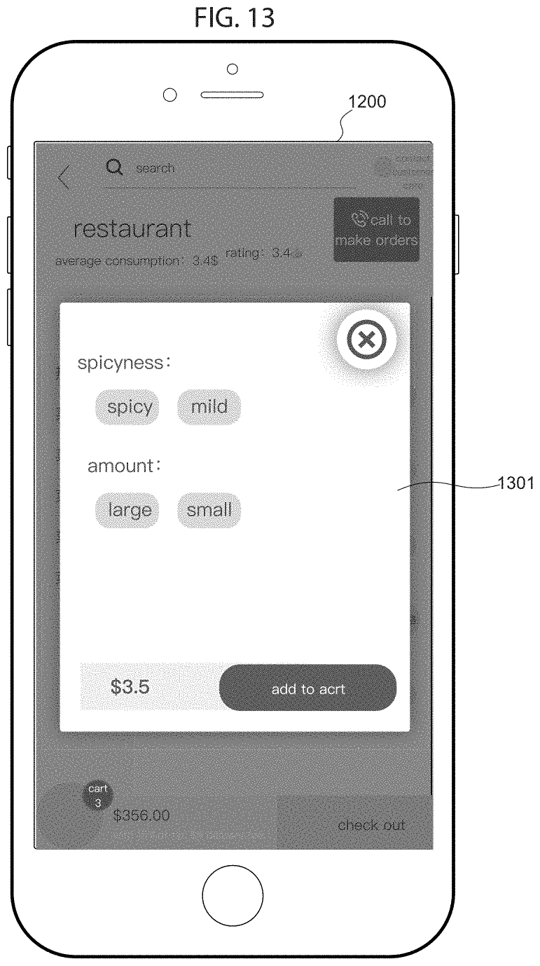

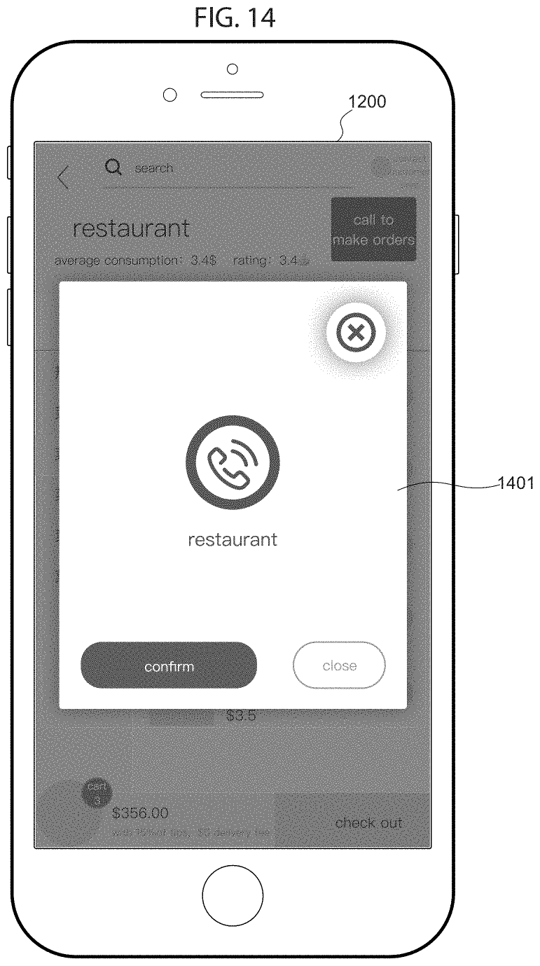

FIG. 12 illustrates an exemplary screen output of a GUI for providing a customer client with a customer client portal facilitating review of available menus and ordering directly with a food establishment. More specifically, in exemplary embodiments, a screen 1200 may include a search tool 1201 for searching restaurants participating with the service provider's services; this search tool may enable typical search algorithms without limiting the scope of the present invention. Moreover, a menu display 1203 may be provided for a selected restaurant in which a variety of menu items are selectably displayed for selection by the customer client. When each of the items are selected, a customer may proceed to a check-out for providing payment. However, in some embodiments, for restaurants that will not be accepting purchases directly from a mobile application, screen 1200 may include a call button 1202 for calling the selected food establishment and making an order. As mentioned above, upon pressing call button 1202 the client device may initiate a food ordering call between the customer and the selected food establishment. FIG. 13 illustrates an exemplary screen output of a GUI including a pop-up window or dialog box for facilitating a selection of options. For example, options may include a portion size, a flavor, spicy level, etc. In cases in which selection of options is not available, and or a call is preferably initiated by the customer, a pop-up window or dialog box for confirming a call to a food establishment may be presented. For example, FIG. 14 illustrates such exemplary screen output of a GUI.

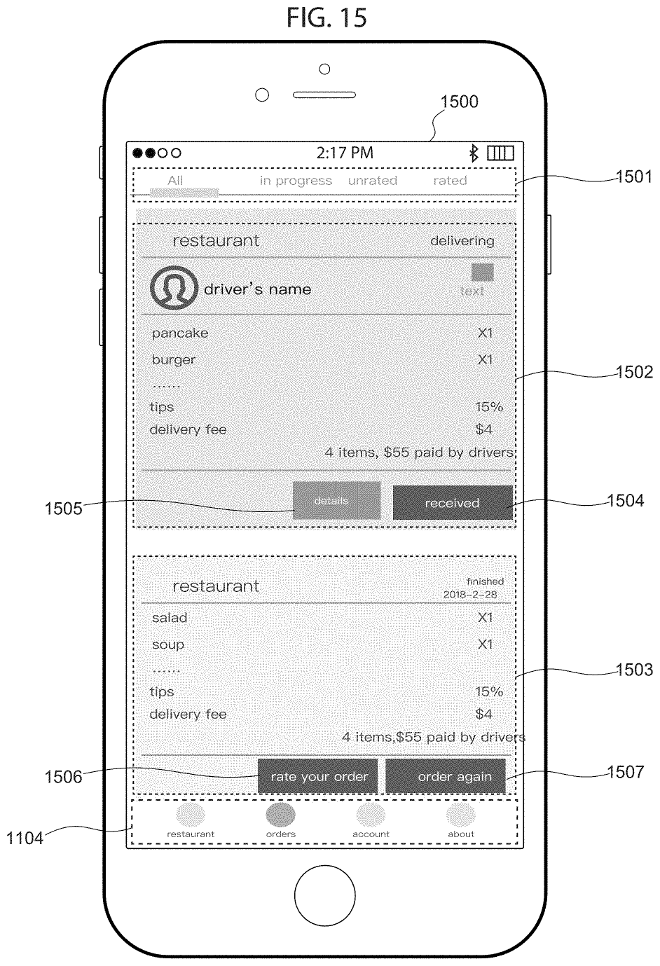

FIG. 15 illustrates an exemplary screen output of a GUI for providing a customer client with a customer client portal facilitating review of past and pending or in-progress orders. More specifically, in some embodiments, screen 1500 may provide a navigation menu 1501 for navigating between past and in-progress orders. Without limiting the scope of the present invention, past orders may be further categorized and or organized as unrated and rated past orders. This way, customers may review their past orders and provide a rating for publication. Unrated orders may stay in their account to be rated at a later date. Screen 1500 may include a summary view of a pending order 1502 and a summary view of a previously delivered order 1503. Because pending order 1502 has not been received, a selectable button 1504 for confirming receipt of the order may be provided. Similarly, a detail view button may be provided for viewing the details of the pending order. Previously delivered order 1503 may include buttons 1506 and 1507 to rate the order or order again.

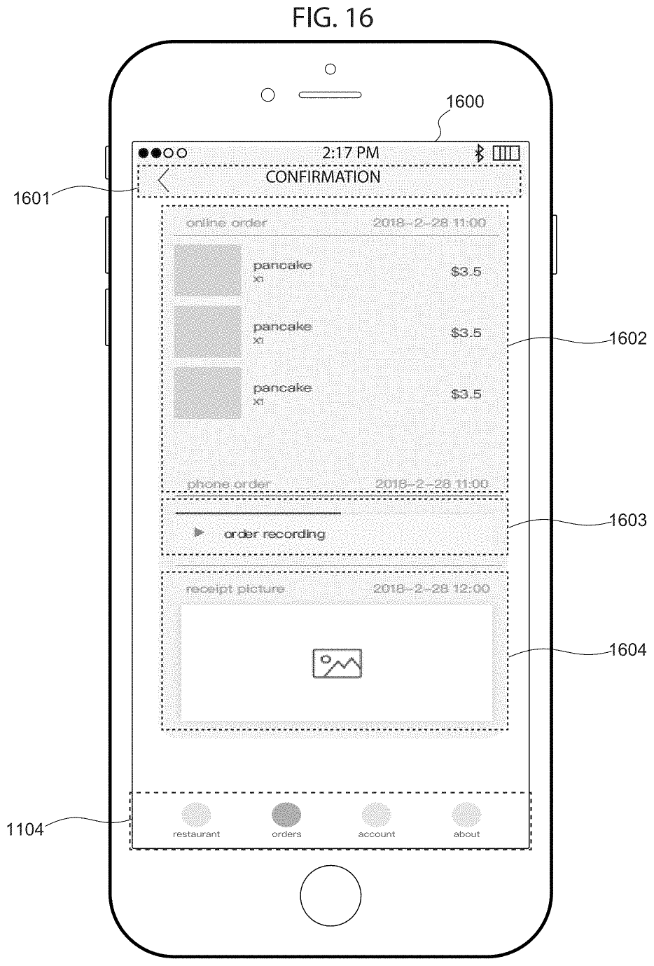

FIG. 16 illustrates an exemplary screen output of a GUI for providing a customer client with a customer client portal facilitating review of a confirmed order. More specifically, in some exemplary embodiments, upon confirming receipt of an order a confirmation screen 1600 may be provided. Screen 1600 may include a navigational button 1601 (for example for going back to a previous screen such as screen 1500 where a user may have selected receipt button 1504), as well as an order receipt or order summary 1602 in which information about the order such as ordered items and costs are itemized for the customer. Moreover, a recording 1603 may be provided of the recorded order between the customer and the food establishment. Additionally, an image 1604 of the receipt provided by the driver may be included as well for the customer's records.

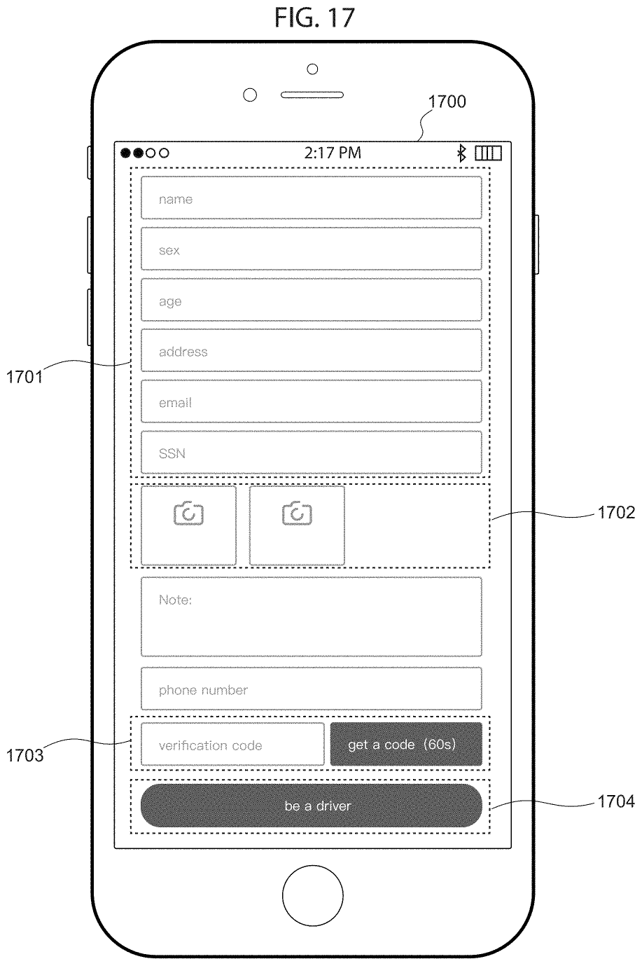

Turning now to the next set of figures, FIG. 17-FIG. 25 illustrate exemplary screen outputs of a GUI employing a delivery client portal in accordance with the present invention.

FIG. 17 illustrates an exemplary screen output of a GUI for providing a delivery client with a delivery client portal facilitating signing up to a delivery service in accordance with the present invention. More specifically, in exemplary embodiments, a screen 1700 may display a variety of data entry fields 1701 for receiving information from a user that is interested in the service provider's services such as delivery services—and particularly interested in being a delivery client such as a delivery driver for the service provider. Without limiting the scope of the present invention, screen 1700 may include field 1702 that may facilitate uploading a first image associated with, for example, a vehicle used by the prospective delivery client. Furthermore, field 1702 may facilitate uploading a second image associated with, for example, the prospective delivery client user. Other means of verification and authentication may be implemented without deviating from the scope of the present invention, such as by implementing a verification means 1703. Typically, upon providing the required information, a submit button 1704 may be pressed by the user to create a login associated with the delivery client.

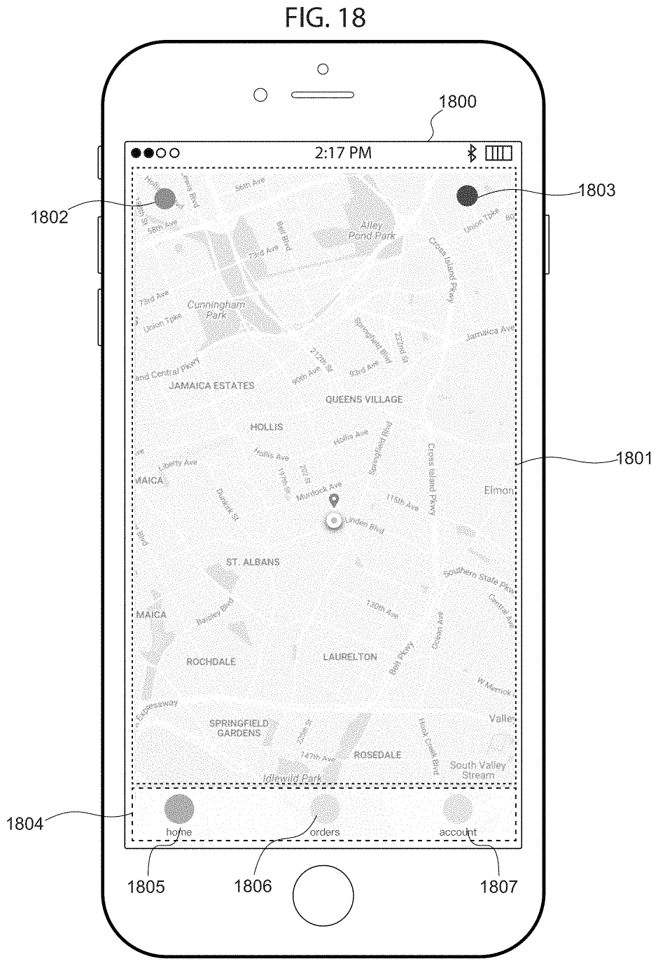

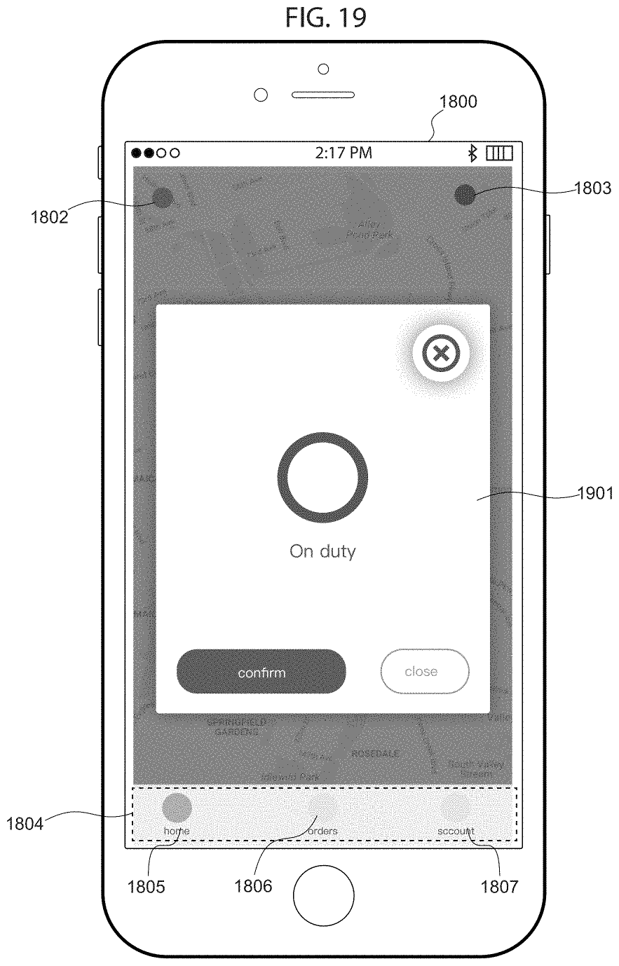

FIG. 18 illustrates an exemplary screen output of a GUI for providing a delivery client with location data associated with one or more orders available to the delivery client. More specifically, in some exemplary embodiments, a screen 1800 may display a map 1801 in which a delivery client user may view available orders for delivery to customer client users. In the embodiment illustrated, above map 1801 an on/off duty indicator 1802 may be provided for the delivery client user to indicate whether they are on or off duty. Additionally, a delivery client help link 1803 may be implemented in case the delivery client user requires assistance. Furthermore, a navigational tool 1804 for navigating throughout the delivery client portal may be provided. Without limiting the scope of the present invention, navigation tool 1804 may include a first button 1805 that may function as a home button, wherein a desktop of tabs and or functions may be provided in a single screen; an order button 1806 may link the user to a control panel for viewing pending, in-progress or available orders for delivery; and an account button 1807 linking the user to an information page about their account. In some embodiments, selecting the on-duty button 1802 may display a pop-up window or dialogue window 1901 as shown in FIG. 19. Once this is confirmed by the delivery client user, one or more orders and their relevant locations (such as a delivery address and a food establishment address) may be displayed on map 1801. The following figure displays an exemplary screen output for an on-duty delivery client user.

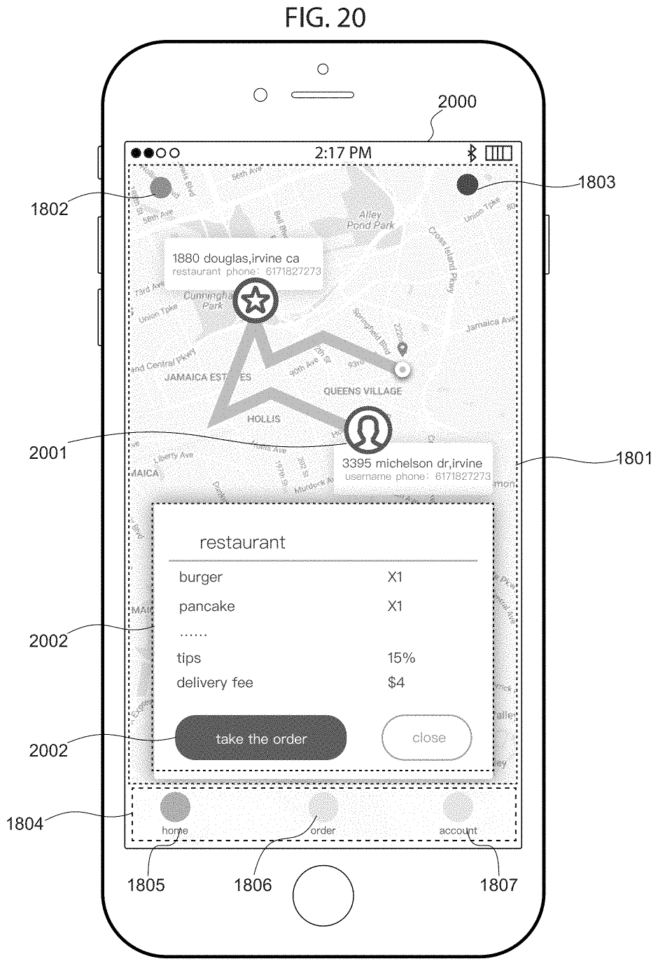

FIG. 20 illustrates an exemplary screen output or screen 2000 depicting map 1801, which displays at least one pending customer order 2001. Selecting an indicator or icon associated with order 2001 may open up or display a dialogue box 2002 including pertinent information about the order 2001 including but not limited to an itemized order and total value as well as an acceptance button 2003 for the delivery client user to accept taking on the order.

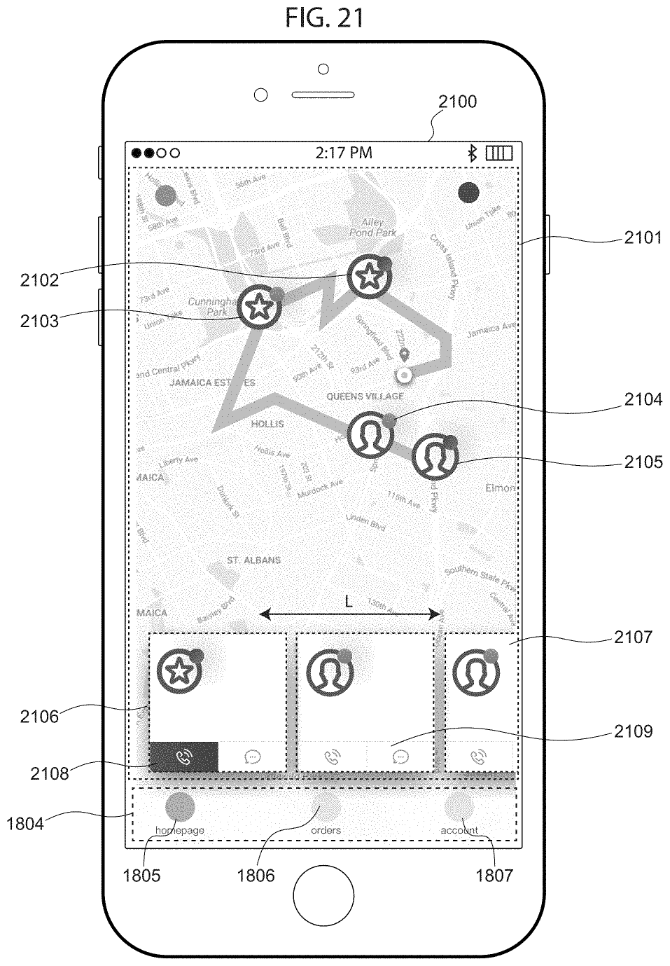

In accordance with some exemplary embodiments of the present invention, a delivery client user may select several orders at one time and manage them from a similar screen 2100. FIG. 21 illustrates an exemplary screen output of a GUI for providing a delivery client with location data associated with one or more orders available to the delivery client. More specifically, screen 2100 includes a map 2101 including a plurality of pending orders 2102 and 2103 for delivery requests from establishments 2104 and 2105, respectively. A current location indicator may typically help the user map a preferred route for servicing each of the selected orders. Furthermore, in some exemplary embodiments, a sliding display tool 2106 may be provided for displaying a plurality of windows 2107, each corresponding to an item identified on map 2101. For example, and without limiting the scope of the present invention, a first window may correspond to pending order 2102, a second window may correspond to pending order 2103, a third window may correspond to a first food establishment 2104 associated with the first pending order 2102, and a fourth window may correspond to a second food establishment 2105 associated with the second pending order 2103. As may be appreciated from the illustrated screen 2100, each window may be viewed, and additional windows may be viewed by sliding the sliding display tool 2106 along a length L of the screen. Further, each window 2107 may provide contact buttons 2108 to initiate a call to a customer client user or a food establishment associated with each window 2107. Similarly, each window 2107 may provide text buttons 2109 to initiate a text message to a customer client user or a food establishment associated with each window 2107.

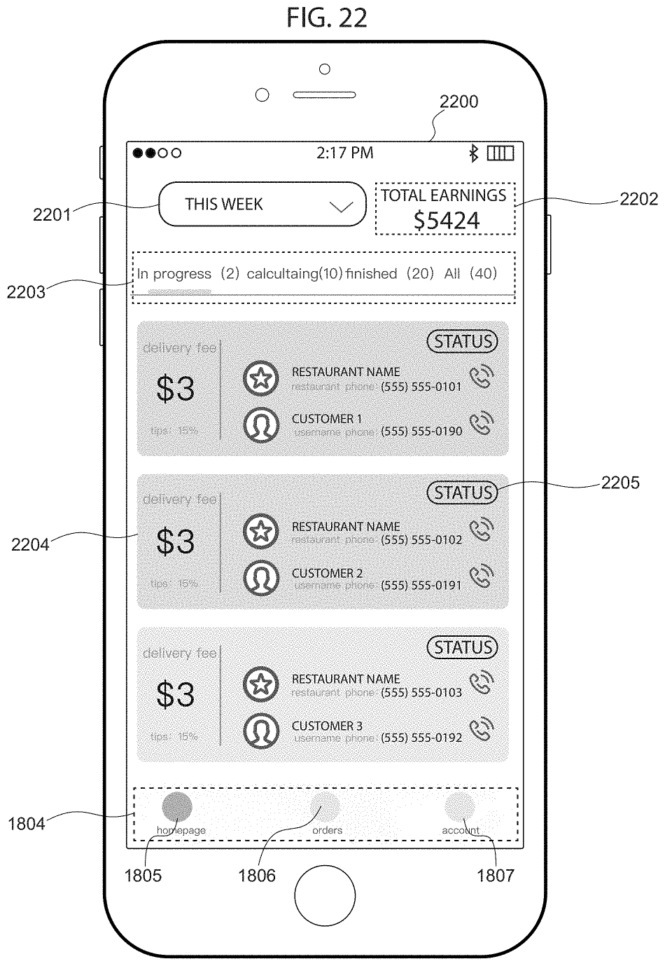

FIG. 22 illustrates an exemplary screen output of a GUI for providing a delivery client with a delivery client portal facilitating review of information pertaining to orders associated with the delivery client. More specifically, in some exemplary embodiments, a screen 2200 may be provided for displaying a total earnings tool that allows delivery client users to select via a selection tool 2201 a range for viewing a total earnings display 2202 for the selected time period. An order navigation menu 2203 may be provided for selecting viewing of in-progress, completed and all orders serviced by the delivery client user. In some embodiments, an in-progress selection (as shown) may include displaying one or more pending or in-progress order summary 2204. Each order summary 2204 may include information such as the delivery fee earned by the driver as well as contact information for the food establishment or restaurant associated with the order 2204 as well as a contact information for a customer associated with the order 2204. In exemplary embodiments, an order status 2205 may also be included so that a delivery client user may glean a status of the order. If servicing a particular order, for example order 2204, a delivery client user may select that order to properly record its service. For example, and without limiting the scope of the present invention, a delivery client user may be provided with a screen to facilitate recording an order pick-up and payment, as shown in the next figure.

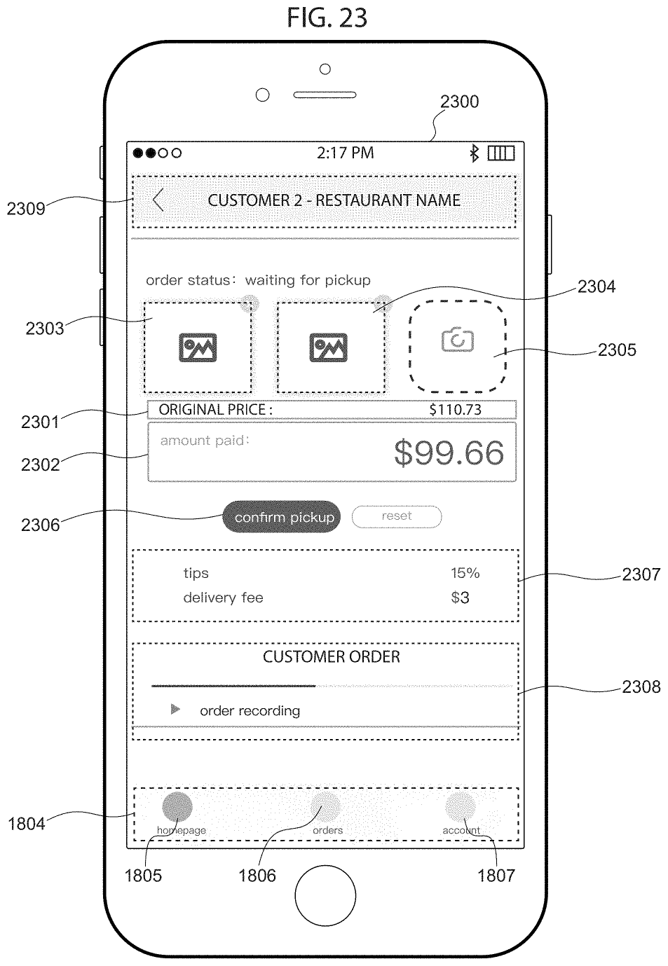

FIG. 23 illustrates an exemplary screen output of a GUI for providing a delivery client with a delivery client portal facilitating confirmation of an order received by the delivery client. More specifically, a screen 2300 is shown displaying details about order 2204 and providing some functionalities that enable a delivery client user such as a delivery driver, to record and confirm that an order from a customer client user was received and paid for. In some exemplary embodiments, a service provider has an arrangement with each food establishment for reduced pricing. As such, the original price of the order 2204 may be provided via an original price display 2301. In such embodiments, screen 2300 also provides the delivery client user with the reduced price of the order 2204 that may be provided via a reduced price display 2302. The delivery client user (when arriving to pick up the order from the food establishment) pays the reduced price. The original price is displayed on the customer client portal to the customer associated with order 2204. As such, the service provider may receive the difference between the original price and the reduced price.

Moreover, in order to keep track of transactions and for purposes of record-keeping, the delivery client user may be prompted to show a first receipt (also to be shared with the customer associated with order 2204) and a second receipt, which must be shown exclusively to the service provider. To these ends, screen 2300 may include image upload functions 2305 for uploading a first image 2303 of the original receipt and uploading a second image 2304 of the receipt between the delivery client user and the food establishment showing that the delivery client user paid the food establishment the reduced fee. In this way, the service provider keeps track of each order via the GUI; when an order is received from the food establishment and paid for, a user may select a confirmation button 2306 to confirm the order and send the uploaded images to the service provider server for recordkeeping. In some exemplary embodiments, the delivery client user may keep a delivery fee and any tips provided to the delivery client user, which may be displayed in a display field 2307. To help the delivery client user verify the accuracy of each order, a customer order recording 2308 may be provided in a manner as discussed above. To help the user navigate away from this window, a navigation tool 2309 may be implemented as well.

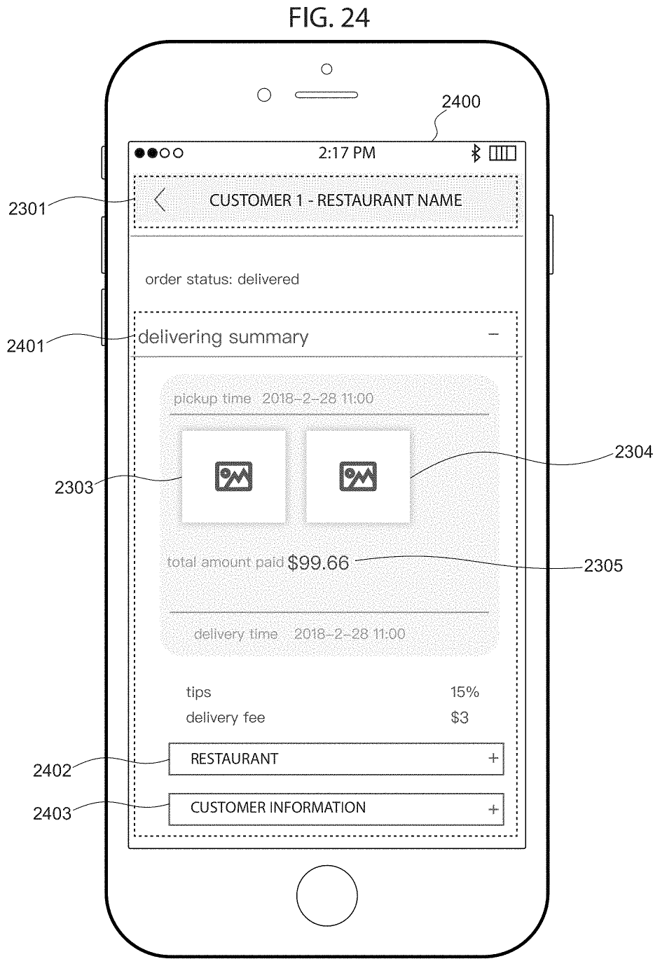

FIG. 24 illustrates an exemplary screen output of a GUI for providing a delivery client with a delivery client portal facilitating confirmation of an order received by the delivery client. More specifically, when a pick-up for an order (such as order 2204) is confirmed as per the discussion above, screen 2400 may be displayed including some of the information in the previous screen as a summary of the order. Moreover, other information may be summarized such as information pertaining to the restaurant associated with the order or customer information associated with the customer of the order. Tabs 2402 and 2403 may be implemented to expand this information.

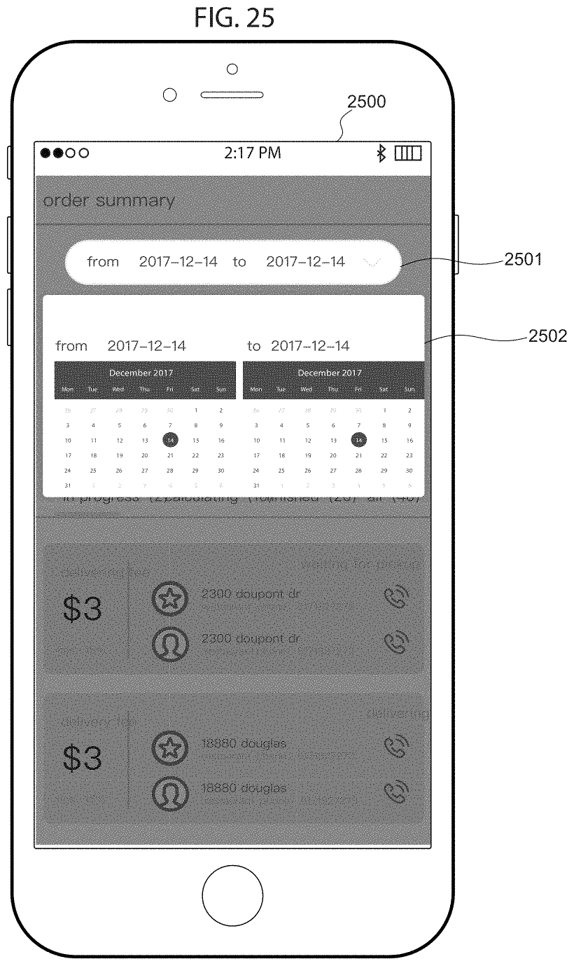

Finally, other tools may be provided in the delivery client portal and or the customer client portal without deviating from the scope of the present invention, employing commonly used tools that may help facilitate management of each user's orders. For example, FIG. 25 illustrates an exemplary screen output (screen 2500) of a GUI for providing a delivery client with a calendar tool 2501 for reviewing a status of one or more orders associated with the delivery client, which may be selected via a range selection tool 2501.

A system and method for order verification in food delivery services has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

What is claimed is:

1. A system for verifying accuracy of a customer food order by way of a graphical user interface (GUI) distributed to a plurality of client devices, comprising:
a first client device of the plurality of client devices with access to a customer portal of the GUI, the GUI configured to initiate a food ordering call between the first client device and a food establishment via one or more windows of the customer portal;
a server in communication with the plurality of client devices, configured to:
connect the first client device with the establishment in response to the first client device initiating the food ordering call;
record the food ordering call; and
provide one or more of the plurality of client devices with a recording of the food ordering call; and
a second client device of the plurality of client devices with access to a driver portal of the GUI, the GUI further configured to provide the second client device with access to the recording of the food ordering call via one or more windows of the driver portal.

2. The system of claim 1, wherein one of the one or more windows of the driver portal comprises:
a first window displaying a list of selectable pending orders to be delivered to one or more users of the plurality of client devices, wherein at least one of the selectable pending orders is a selectable order associated with a user of the first client device.

3. The system of claim 2, wherein one of the one or more windows of the driver portal comprises:
a second window, launched in response to a selection of the selectable order associated with the user of the first client device, the second window displaying a media player configured to play the recording of the food ordering call.

4. The system of claim 3, wherein the second window further displays customer information of the user of the first client device.

5. The system of claim 3, wherein the second window further displays a button for launching directions to an address associated with the user of the first client device.

6. The system of claim 3, wherein the second window further displays a button for launching directions to an address associated with the food establishment.

7. The system of claim 3, wherein one of the one or more windows of the driver portal further comprises a third window displaying access to a list of one or more pending orders, a list of one or more completed orders and a list including an order history of orders assigned to a user of the second client device.

8. The system of claim 1, wherein one of the one or more windows of the customer portal comprises:
a first window displaying a list of selectable menus wherein at least one of the selectable menus is a selectable menu associated with the food establishment.

9. The system of claim 8, wherein one of the one or more windows of the customer portal comprises:
a second window, launched in response to a selection of the selectable menu associated with the food establishment, the second window displaying a menu of the food establishment and a button configured to initiate the food ordering call between the first client device and the food establishment.

10. The system of claim 8, wherein the first window further displays a carousel of selectable food categories.

11. The system of claim 8, wherein the first window further displays a text search box.

12. The system of claim 8, wherein one of the one or more windows of the customer portal comprises a third window for displaying an approximate location of the delivery driver of the second client device.

13. A method, performed by a server and a plurality of client devices, for verifying accuracy of a customer food order by way of a graphical user interface (GUI) distributed to the plurality of client devices, comprising:
providing a first client device of the plurality of client devices with access to a customer portal of the GUI, the GUI configured to initiate a food ordering call between the first client device and a food establishment via one or more windows of the customer portal;
connecting the first client device with the establishment in response to the first client device initiating the food ordering call;
recording the food ordering call; and
providing one or more of the plurality of client devices with a recording of the food ordering call, including providing a second client device of the plurality of client devices with access to a driver portal of the GUI, the GUI further configured to provide the second client device with access to the recording of the food ordering call via one or more windows of the driver portal.

14. The method of claim 13, further comprising:
launching a first window displaying a list of selectable pending orders to be delivered to one or more users of the plurality of client devices, wherein at least one of the selectable pending orders is a selectable order associated with a user of the first client device.

15. The method of claim 14, further comprising:
launching a second window in response to a selection of the selectable order associated with the user of the first client device, the second window displaying a media player configured to play the recording of the food ordering call.

16. The method of claim 15, further comprising:
launching directions to an address associated with the user of the first client device in response to the user of the second client device selecting a button displayed on the second window.

17. The method of claim 15, further comprising:
launching directions to an address associated with the food establishment in response to the user of the second client device selecting a button displayed on the second window.

18. The method of claim 13, further comprising:
launching a first window displaying a list of selectable menus wherein at least one of the selectable menus is a selectable menu associated with the food establishment.

19. The system of claim 18, further comprising:
launching a second window in response to a selection of the selectable menu associated with the food establishment, the second window displaying a menu of the food establishment and a button configured to initiate the food ordering call between the first client device and the food establishment.

20. A system for verifying accuracy of a customer food order by way of a graphical user interface (GUI) distributed to a plurality of client devices, comprising:
a first client device of the plurality of client devices with access to a customer portal of the GUI, the GUI configured to initiate a food ordering call between the first client device and a food establishment via one or more windows of the customer portal;
a server in communication with the plurality of client devices, configured to:
connect the first client device with the establishment in response to the first client device initiating the food ordering call;
record the food ordering call; and
provide one or more of the plurality of client devices with a recording of the food ordering call; and
a second client device of the plurality of client devices with access to a driver portal of the GUI, the GUI further configured to provide the second client device with access to the recording of the food ordering call via one or more windows of the driver portal;
wherein one of the one or more windows of the driver portal comprises:
a first window displaying a list of selectable pending orders to be delivered to one or more users of the plurality of client devices, wherein at least one of the selectable pending orders is a selectable order associated with a user of the first client device; and
a second window, launched in response to a selection of the selectable order associated with the user of the first client device, the second window displaying a media player configured to play the recording of the food ordering call; and
wherein one of the one or more windows of the customer portal comprises:
a first window displaying a list of selectable menus wherein at least one of the selectable menus is a selectable menu associated with the food establishment;
a second window, launched in response to a selection of the selectable menu associated with the food establishment, the second window displaying a menu of the food establishment and a button configured to initiate the food ordering call between the first client device and the food establishment; and
a third window for displaying an approximate location of the delivery driver of the second client device.
